(19) United States
(12) Patent Application Publication
(10) Pub. No.: US 2014/0082624 A1
(43) Pub. Date: Mar. 20, 2014

(54) EXECUTION CONTROL METHOD AND MULTI-PROCESSOR SYSTEM

(71) Applicant: Fujitsu Semiconductor Limited, Yokohama-shi (JP)

(72) Inventor: Hiroshi IWABUCHI, Sendai (JP)

(73) Assignee: Fujitsu Semiconductor Limited, Yokohama-shi (JP)

(21) Appl. No.: 13/955,732

(22) Filed: Jul. 31, 2013

(30) Foreign Application Priority Data
Sep. 19, 2012 (JP) 2012-206398

(51) Int. Cl. G06F 9/48

(52) U.S. Cl. CPC G06F 9/4881
USPC 718/102

(57) ABSTRACT

An execution control method is executed by a first processor of a multi-processor system controlled by plural operating systems (OSs). The execution control method includes determining by referring to first information that is stored in a storage unit and identifies a synchronization process for threads executed by OSs that are different from one another and among the OSs, whether a synchronization process for which an execution request is issued by a thread that is executed by a first OS that is among the OSs and controls the first processor, is the synchronization process for threads executed by OSs that are different from one another; and upon determining so, causing the first OS to execute the synchronization process for which the execution request is issued, using a storage area accessible by the first OS and specific to the first processor.

### CROSS REFERENCE TO RELATED APPLICATIONS

This application is based upon and claims the benefit of priority of the prior Japanese Patent Application No. 2012-206398, filed on Sep. 19, 2012, the entire contents of which are incorporated herein by reference.

### FIELD

The embodiments discussed herein are related to an execution control method and a multi-processor system.

### BACKGROUND

One conventional system is controlled by plural operating systems (OSs). For example, according to one technique, an OS executed preferentially by a processor is switched based on the priority level of the threads to be executed on plural OSs. According to another technique, a system executing plural OSs by plural processors includes a processing unit that executes processes that are each specific to any one of the OSs and another processing unit that executes parallel processing executed by the OSs; and determines the OS to execute the parallel processing (see, e.g., Japanese Laid-Open Publication Nos. 2000-242512 and 2009-163527).

However, in a multi-processor system to which the conventional techniques are applied and that executes plural OSs using plural CPUs, the processing performance of the multi-processor system is degraded by a process of synchronizing threads executed by OSs different from one another.

### SUMMARY

According to an aspect of an embodiment, an execution control method is executed by a first processor of a multi-processor system controlled by plural operating systems (OSs). The execution control method includes determining by referring to first information that is stored in a storage unit and identifies a synchronization process for threads executed by OSs that are different from one another and among the OSs, whether a synchronization process for which an execution request is issued by a thread that is executed by a first OS that is among the OSs and controls the first processor, is the synchronization process for threads executed by OSs that are different from one another; and causing the first OS to execute the synchronization process for which the execution request is issued, using a storage area accessible by the first OS and specific to the first processor, upon determining that the synchronization process is not the synchronization process for threads executed by OSs that are different from one another and among the OSs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of operation of a multi-processor system according to an embodiment;

FIG. 2 is a block diagram of a hardware configuration of the multi-processor system according to the embodiment;

FIG. 3 is an explanatory diagram of an example of the connection of CPUs and memory to each other;

FIG. 4 is a block diagram of an example of a functional configuration of the multi-processor system;

FIG. 5 is an explanatory diagram of an example of the contents of a thread and OS correlation table;

FIG. 6 is an explanatory diagram of an example of the contents of a thread and synchronization process ID correlation table;

FIG. 7 is an explanatory diagram of an example of the contents of a synchronization process ID and OS correlation table;

FIG. 8 is an explanatory diagram of an example of the contents of management information;

FIG. 9 is an explanatory diagram of an example of updating of the synchronization process ID and OS correlation table;

FIG. 10 is a flowchart of an example of a procedure for an executing entity determination process for the synchronization process;

FIG. 11 is a flowchart of an example of a procedure for an updating process for the thread and OS correlation table;

FIG. 12 is a flowchart of an example of a procedure for an updating process for the synchronization process ID and OS correlation table;

FIG. 13 is an explanatory diagram of an example of the contents of a CPU assignment table;

FIG. 14 is an explanatory diagram of an example of the contents of a thread information table;

FIG. 15 is an explanatory diagram of an example of the contents of an assignable OS count table;

FIG. 16 is an explanatory diagram of an example of the contents of a CPU state table;

FIG. 17 is an explanatory diagram of an example of the contents of a thread assignment schedule storage table;

FIG. 18 is an explanatory diagram of an assignment state of threads before execution of unified scheduling;

FIG. 19 is an explanatory diagram of a first stage of a search process of the unified scheduling;

FIG. 20 is an explanatory diagram of a second stage of the search process of the unified scheduling;

FIG. 21 is an explanatory diagram of a third stage of the search process of the unified scheduling;

FIG. 22 is an explanatory diagram of a fourth stage of the search process of the unified scheduling;

FIG. 23 is an explanatory diagram of a fifth stage of the search process of the unified scheduling;

FIG. 24 is an explanatory diagram of a sixth stage of the search process of the unified scheduling;

FIG. 25 is an explanatory diagram of a seventh stage of the search process of the unified scheduling;

FIG. 26 is an explanatory diagram of an eighth stage of the search process of the unified scheduling;

FIG. 27 is an explanatory diagram of a ninth stage of the search process of the unified scheduling;

FIG. 28 is an explanatory diagram of a first stage of a stopping and restarting process of the unified scheduling;

FIG. 29 is an explanatory diagram of a second stage of the stopping and restarting process of the unified scheduling;

FIG. 30 is an explanatory diagram of a third stage of the stopping and restarting process of the unified scheduling;

FIG. 31 is an explanatory diagram of a fourth stage of the stopping and restarting process of the unified scheduling;

FIG. 32 is an explanatory diagram of a fifth stage of the stopping and restarting process of the unified scheduling;

FIG. 33 is an explanatory diagram of a sixth stage of the stopping and restarting process of the unified scheduling;

FIG. 34 is a flowchart of an example of a procedure for a process of the unified scheduling;

FIG. 35 is a flowchart of an example of a procedure for a pre-process of the unified scheduling;

FIG. 36 is a flowchart of an example of a procedure for the search process of the unified scheduling;

FIG. 37 is a flowchart (Part I) of an example of a procedure for the stopping and restarting process of the unified scheduling; and

FIG. 38 is a flowchart (Part II) of the example of the procedure for the stopping and restarting process of the unified scheduling.

### DESCRIPTION OF EMBODIMENTS

An execution control method and multi-processor system will be described in detail with reference to the accompanying drawings.

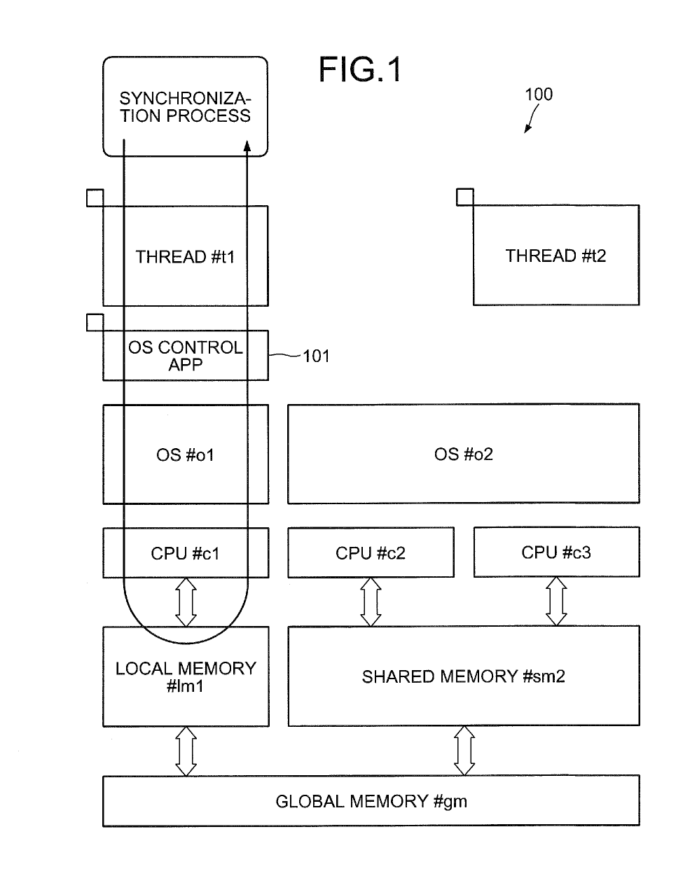

FIG. 1 is an explanatory diagram of an example of operation of a multi-processor system according to an embodiment. The multi-processor system 100 includes central processing units (CPUs) #c1 to #c3, local memory #lm1, shared memory #sm2, and global memory #gm. Hereinafter, each postfix symbol including “#” and thereafter will also be used as identification information for hardware and software components in FIGS. 1 to 38.

The multi-processor system is a computer system that includes plural processors. Alternatively, one processor may include plural cores. In the embodiment, description will be given taking an example of a configuration that includes plural CPUs that are respectively single-core processors connected in parallel.

The CPUs #c2 and #c3 are processors having a common instruction set and a common register set. The CPUs #c1 and #c2 are CPUs having instruction sets different from one another and register sets different from one another. As described, the multi-processor system 100 is a heterogeneous processor. To control the CPUs #c1 to #c3 using one OS, the processing amount is increased to address inconsistencies arising from the differences between the instruction sets, between the register sets, and between caches, to establish coherency among the cache. Therefore, the multi-processor system 100 controls the CPU #c1 using an OS #o1 and controls the CPUs #c2 and #c3 using an OS #o2 that is different from the OS #o1. The OS #o1 executes a thread #t1 and the OS #o2 executes a thread #t2.

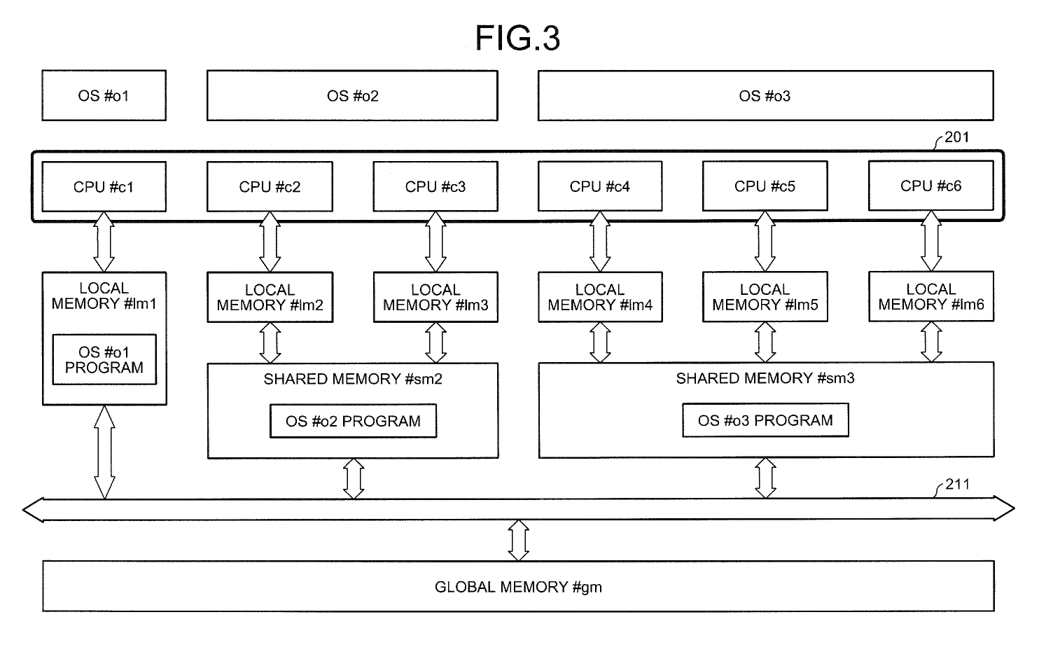

The CPUs, the local memory #lm1, the shared memory #sm2, and the global memory #gm will be described. The local memory #lm1 is a storage device specific to the CPU #c1. A storage device may be present that is specific to each of the CPUs #c2 and #c3. Description will be made later with reference to FIG. 3 including description for the storage devices specific to the CPUs #c2 and #c3. The shared memory #sm2 is a storage device shared between the CPUs #c2 and #c3. The global memory #gm is a storage device shared among the CPUs #c1 to #c3. The reading and writing speeds of the storage devices are faster the closer the storage device is to the CPUs, among the storage devices including the local memory #lm, the shared memory #sm, and the global memory #gm.

The threads #t1 and #t2 will be described. A “thread” is a unit into which a program is divided for execution and is also referred to as “task” depending on the type of the OS. In the embodiment, description will be given using “thread” for standardization. The types of states of a thread include an execution state in which the thread is assigned to a CPU by an OS and is under execution, and an executable state in which the thread is not assigned to any CPU and awaits execution consequent to an execution request.

An OS control app 101 is software executed on the OS #o1 and is also executable on the OS #o2. When the synchronization process is executed, the OS control app 101 changes the location at which information that is used in the synchronization process is stored, to facilitate improvement of the processing performance. The OS control app 101 may execute scheduling of the threads for the entire multi-processor system 100. Hereinafter, the scheduling executed by the OS control app 101 will be referred to as “unified scheduling”.

The “synchronization process” refers to a process of controlling the processing of plural threads. Types of synchronization processes include, for example, a semaphore, an event flag, a mail box, and a memory pool. For example, when one value is shared among plural threads, the plural threads can realize sharing of the value using the semaphore. In this sharing, the information used by the semaphore is stored in the global memory #gm enabling access of the information by the plural OSs. The OS control app 101 executed by the CPU #c1 to be a first CPU of the multi-processor system 100 changes the location at which the information used in the synchronization process is stored to facilitate the improvement of the processing performance.

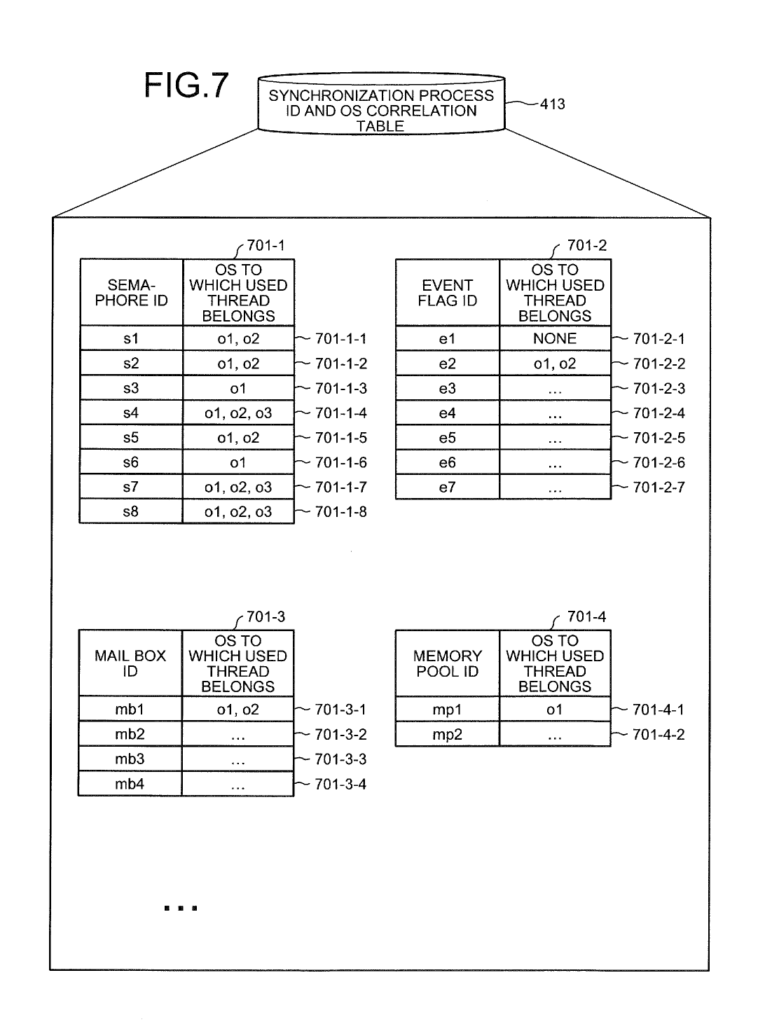

The OS control app 101 determines whether the synchronization process for which an execution request is issued by the thread #t1 executed by the OS #o1 to be a first OS, is a synchronization process for the threads executed by OSs that are different from one another. For example, the OS control app 101 executes hooking for the address of an application programming interface (API) of the synchronization process to be invoked by the thread and thereby, the OS control app 101 can detect the synchronization process for which the execution request is issued, as a method of detecting the synchronization process for which the execution request is issued. The OS control app 101 refers to a storage unit that stores first information to identify the synchronization process for the threads executed by OSs that are different from one another, as a specific method for the determination. The stored contents will be described later with reference to FIG. 7.

If the OS control app 101 determines that the synchronization process is not a synchronization process for the threads executed by OSs that are different from one another, the OS control app 101 executes the synchronization process for which the execution request is issued using the local memory #lm1 that is a storage area specific to the CPU #c1.

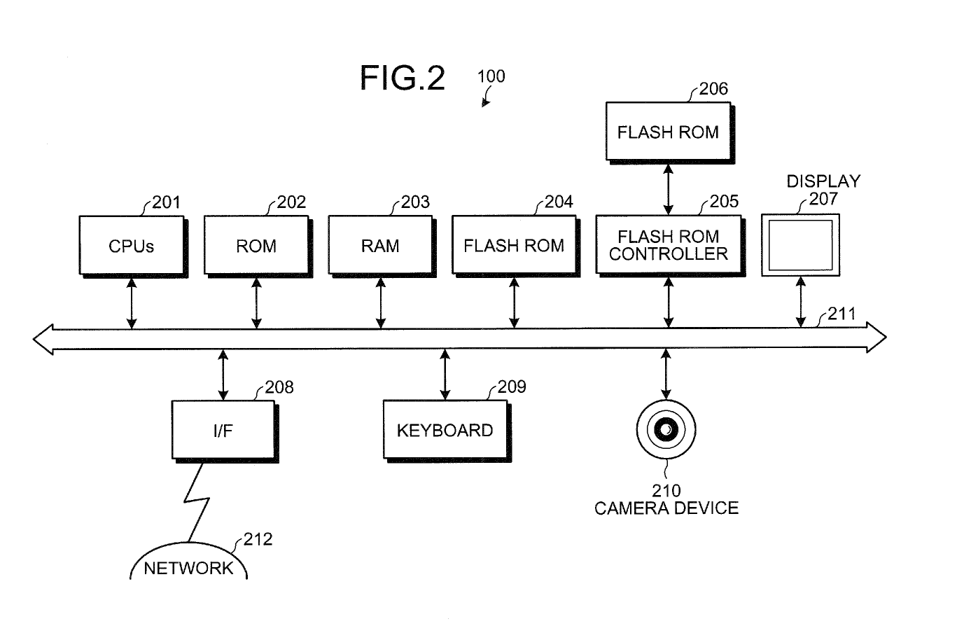

As described, if a synchronization process executed by an OS is not invoked by a thread executed by another OS, the OS control app 101 executes the synchronization process using the storage area specific to the CPU executing the OS. Thereby, for the synchronization process for which no memory coherency needs to be established, the global memory #gm, which is a storage area shared among the CPUs, does not have to be used and therefore, the processing performance of the multi-processor system 100 improves. The multi-processor system 100 will be described in detail with reference to FIGS. 2 to 38.

FIG. 2 is a block diagram of a hardware configuration of the multi-processor system according to the embodiment. As depicted in FIG. 2, a multi-processor system 100 includes multiple central processing units (CPUs) 201, read-only memory (ROM) 202, random access memory (RAM) 203, flash ROM 204, a flash ROM controller 205, and flash ROM 206. The multi-processor system includes a display 207, an interface (I/F) 208, a keyboard 209, and a camera device 210. Further, the global memory #gm depicted in FIG. 1 is formed by storage devices including the RAM 203, the flash ROM 204, and the flash ROM 206.

The CPUs 201 govern overall control of the multi-processor system 100. An example of the CPUs 201 will be described with reference to FIG. 3. The ROM 202 stores programs such as a boot program. The RAM 203 is used as a work area of the CPUs 201. The flash ROM 204 is re-writable, non-volatile memory. For example, the flash ROM 204 may be NOR-type flash memory enabling high-speed reading. The flash ROM 204 stores system software such as an operating system (OS), and application software. For example, when the OS is updated, the multi-processor system 100 receives a new OS via the I/F 208 and updates the old OS that is stored in the flash ROM 204 with the received new OS.

The flash ROM controller 205, under the control of the CPUs 201, controls the reading and writing of data with respect to the flash ROM 206. The flash ROM 206 is re-writable, non-volatile memory and is NAND-type flash memory primarily intended for data storage and transfer. The flash ROM 206 stores data written under control of the flash ROM controller 205. Examples of the data include image data and video data acquired by the user of the multi-processor system through the I/F 208. The flash ROM 206 may further store a program causing execution of the execution control method according to the embodiment. A memory card, SD card and the like may be adopted as the flash ROM 206.

The display 207 displays, for example, data such as text, images, functional information, etc., in addition to a cursor, icons, and/or tool boxes. A thin-film-transistor (TFT) liquid crystal display and the like may be employed as the display 207.

The I/F 208 is connected to a network 212 such as a local area network (LAN), a wide area network (WAN), and the Internet through a communication line and is connected to other apparatuses through the network 212. The I/F 208 administers an internal interface with the network 212 and controls the input and output of data with respect to external apparatuses. For example, a modem or a LAN adaptor may be employed as the I/F 208.

The keyboard 209 includes, for example, keys for inputting letters, numerals, and various instructions and performs the input of data. Alternatively, a touch-panel-type input pad or numeric keypad, etc. may be adopted. The camera device 210 is a device that captures still or moving images.

FIG. 3 is an explanatory diagram of an example of the connection of the CPUs and the memory to each other. A group of CPUs included among the CPUs 201, the local memory #lm, the shared memory #sm, and the global memory #gm that each are accessible from the group of CPUs will be described with reference to FIG. 3.

The CPUs 201 include the CPUs #c1 to #c3 that are the processors having a common instruction set and a common register, and CPUs #c4 to #c6 that are the processors having a common instruction set and a common register set, respectively difference from those of the CPUs #c1 to #c3. The CPUs #c2 and #c3 may each have processing performance that is different from one another if the CPUs #c2 and #c3 have the same instruction set and the same register set. Similarly, the CPUs #c4 to #c6 may each have processing performance that is different from one another is the CPUs #c4 to #c6 have the same instruction set and the same register set.

The OS #o1 is an OS executed by the CPU #c1. The OS #o2 is an OS executed by the CPUs #c2 and #c3. An OS #o3 is an OS executed by the CPUs #c4 to #c6.

The local memory #lm1 and local memory #lm2 to #lm6 are storage devices respectively specific to the CPUs #c1 to #c6. The local memory #lm1 to #lm6 each store, for example, data used by each CPU. The local memory #lm1 stores an OS-#o1 program that is program data of the OS #o1. The program data of an OS includes instruction code strings that do not change, fixed variables and tables; variables that change and have initial values and tables; and variables that have no initial values and tables.

The shared memory #sm2 is a storage device that is shared between the CPUs #c2 and #c3. Shared memory #sm3 is a storage device that is shared among the CPUs #c4 to #c6. The shared memory #sm2 stores an OS-#o2 program that is program data for the OS #o2. Similarly, the shared memory #sm3 stores an OS-#o3 program that is program data for the OS #o3.

The global memory #gm is a storage apparatus that is shared among the CPUs #c1 to #c6. The reading and writing speeds of the storage devices are faster the closer the storage device is to the CPUs, among the storage devices including the local memory #lm, the shared memory #sm, and the global memory #gm. Taking the CPU #c2 as an example, the reading and writing speeds are the highest for the local memory #lm2 followed by the shared memory #sm2 and the global memory #gm in descending order.

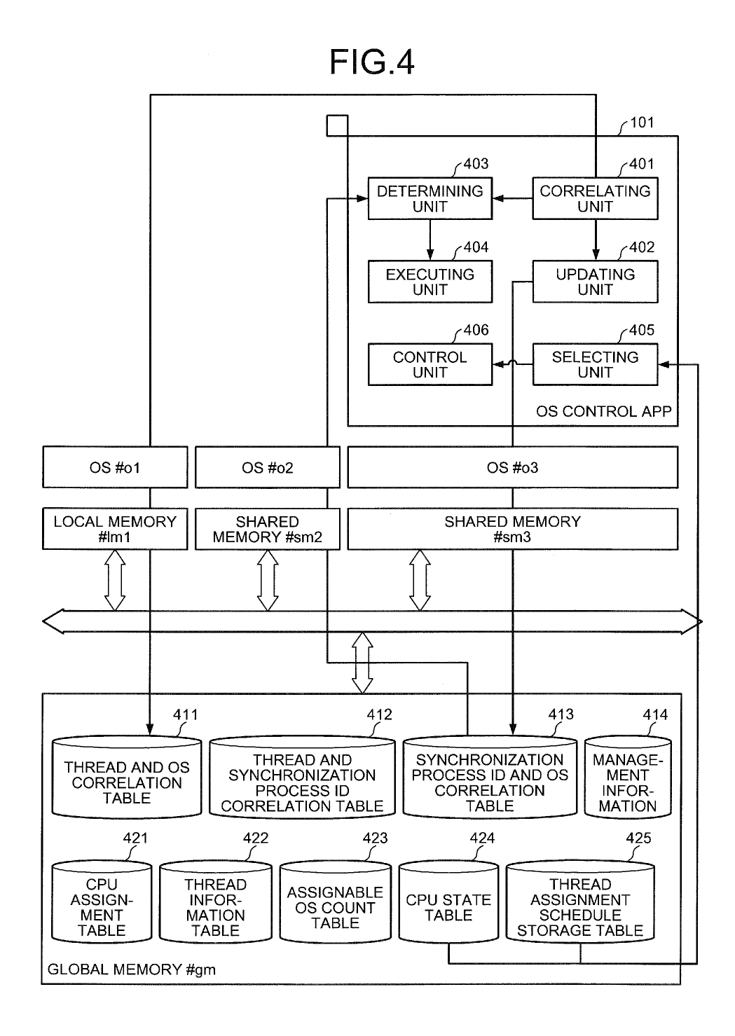

FIG. 4 is a block diagram of an example of a functional configuration of the multi-processor system. The multi-processor system 100 includes a correlating unit 401, an updating unit 402, a determining unit 403, an executing unit 404, a selecting unit 405, and a control unit 406. Functions of the units from the correlating unit 401 to the control unit 406 are implemented by executing on any one of the CPUs #c1 to #c6, program code of the OS control app 101 that is stored in a storage device. The “storage device” refers to, for example, the local memory #lm, the shared memory #sm, or the global memory #gm. In FIG. 4, the units from the correlating unit 401 to the control unit 406 are depicted as the functions of the OS #o3. However, the units may be the functions of the OS #o1 or #o2.

The multi-processor system 100 can access a thread and OS correlation table 411, a thread and synchronization process ID correlation table 412, a synchronization process ID and OS correlation table 413, and management information 414. The multi-processor system 100 can access a CPU assignment table 421, a thread information table 422, an assignable OS count table 423, a CPU state table 424, and a thread assignment schedule storage table 425.

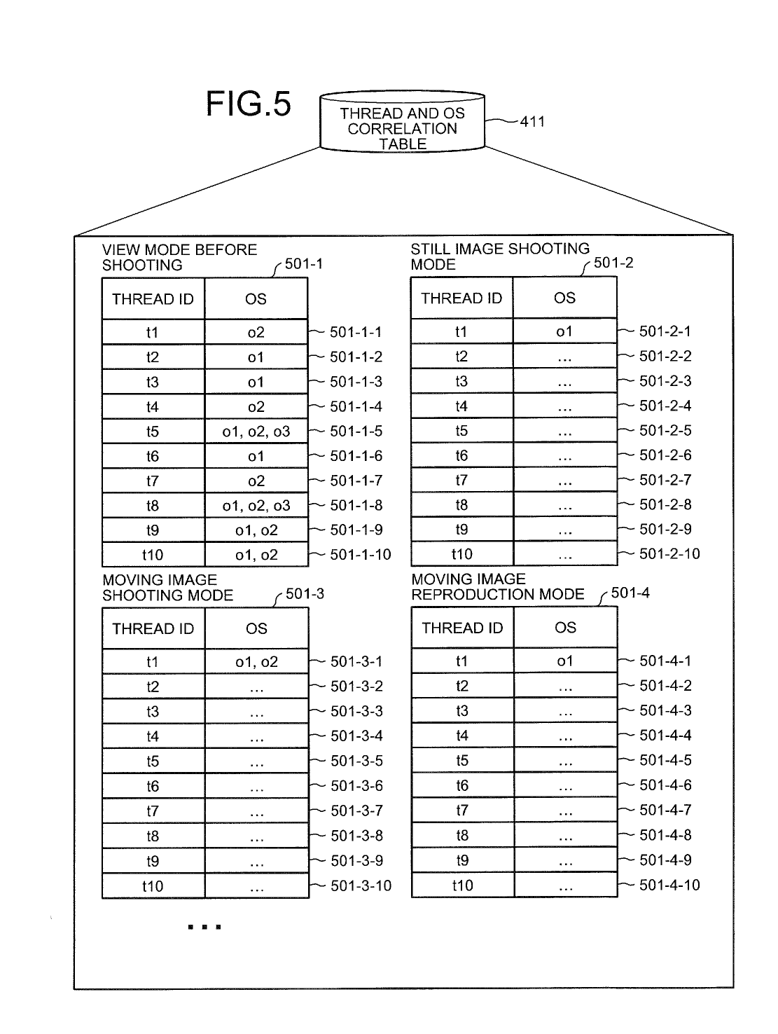

The tables and the information from the thread and OS correlation table 411 to the management information 414 and the CPU assignment table 421 to the thread assignment schedule storage table 425 are stored in the global memory #gm. Detailed description of the tables and the information from the thread and OS correlation table 411 to the management information 414 and the CPU assignment table 421 to the thread assignment schedule storage table 425 will be made later with reference to FIGS. 5 to 8 and 13 to 17.

The synchronization process ID and OS correlation table 413 stores the first information that is used to identify the synchronization process for the threads executed by OSs that are different from one another. The first information includes, for example, identification information concerning the synchronization process, and a value that indicates whether the corresponding synchronization process is a synchronization process for the threads executed by OSs that are different from one another. The first information may include identification information of the synchronization process, and identification information of the OS executing the thread that issues the execution request for the corresponding synchronization process.

When any one of the OSs executes the thread that issues the execution request for the synchronization process, the correlating unit 401 correlates the thread that issues the execution request for the synchronization process and the OS that executes the thread. For example, when the OS #o1 executes the thread #t1, the correlating unit 401 correlates the thread #t1 with the OS #o1. The correlating unit 401 may refer to the thread and synchronization process ID correlation table 412 or may refer to information storing the synchronization process for which the execution request is issued by the thread, to identify which thread issues the execution request for the synchronization process. The correlated information is stored in the local memory #lm, the thread and OS correlation table 411, etc.

The updating unit 402 updates the first information that is stored in the synchronization process ID and OS correlation table 413 and that is used to identify the synchronization process for threads executed by the OSs that are different from one another, based on the result of the correlation by the correlating unit 401. For example, it is assumed that the correlating unit 401 correlates the thread #t1 with the OS #o1 and then, the thread #t1 with the OS #o2. In this case, assuming that the synchronization process for which the execution request is issued by the thread #t1 is the synchronization process for the threads executed by the OSs that are different from one another, the updating unit 402 updates the synchronization process ID and OS correlation table 413.

The determining unit 403 determines, by referring to the first information, whether the synchronization process for which the execution request is issued by the thread executed by the first OS among the OSs each controlling the first CPU, is a synchronization process for threads executed by OSs that are different from one another. For example, a state is assumed where the synchronization process ID and OS correlation table 413 correlates and stores a semaphore ID #s1 and the OSs #o1 and #o2. In this state, when an execution request for the semaphore ID #s1 is issued, the determining unit 403 determines that the synchronization process for which the execution request is issued is a synchronization process for threads executed by OSs that are different from one another.

The determining unit 403 may determine whether the synchronization process for which the execution request is issued by the thread is a synchronization process for threads executed by OSs of the same type among the CPUs, by referring to the first information.

The determining unit 403 may determine whether the synchronization process for which the execution request is issued is a synchronization process for threads executed by OSs of the same type, by referring to the first information updated by the updating unit 402. For example, it is assumed that the determining unit 403 stores correlated with each other, the semaphore ID #s1, the OS #o1, and an OS #o1′ of the same type as that of the OS #o1. In this case, the determining unit 403 determines that the semaphore ID #s1 is a synchronization process for threads that are executed by OSs of the same type.

The determining unit 403 determines whether the synchronization process for which the execution request is issued is a synchronization process for threads executed by OSs that are different from one another, based on the operation mode of the multi-processor system 100 by referring to the first information. The “operation mode” of the multi-processor system 100 is designated by a user, etc. and represents the operation state of the multi-processor system 100. When the operation mode is changed, a thread may be present for which an execution request has been issued and whether the execution request is executed changes. Determination results are stored in the local memory #lm, etc.

If the determining unit 403 determines that the synchronization process for which the execution request is issued is not a synchronization process for threads executed by OSs that are different form each other, the executing unit 404 executes the synchronization process for which the execution request is issued, using a storage area specific to the first CPU that can be accessed by the first OS. For example, the executing unit 404 executes the synchronization process for which the execution request is issued, using the local memory #lm. For example, the OS may execute the synchronization process or the OS control app 101 may execute the synchronization process, as the executing unit 404.

If the determining unit 403 determines that the synchronization process for which the execution request is issued is a synchronization process for threads executed by OSs of the same type, the executing unit 404 may execute the synchronization process for which the execution request is issued, using a storage area that can be accessed by OSs of the same type. It is assumed that, for example, the determining unit 403 determines that the synchronization process is a synchronization process for threads executed by the OS #o1 and those executed by the OS #o1′ of the same type as that of the OS #o1. In this case, the executing unit 404 may execute the synchronization process for which the execution request is issued, using a storage area that can be accessed by the OSs #o1 and #o1′. Thus, execution of the synchronization process is enabled while avoiding as much as possible the storage areas that are accessed by many CPUs, whereby the processing performance of the multi-processor system 100 can be improved.

If the determining unit 403 determines that the synchronization process for which the execution request is issued is a synchronization process for threads executed by OSs that are different from one another, the executing unit 404 may execute the synchronization process for which the execution request is issued, using a storage area that can be accessed by plural OSs. For example, the executing unit 404 executes the synchronization process for which the execution request is issued, using the global memory #gm.

When an OS whose execution of all the threads assigned thereto comes to an end is detected from among the OSs, the selecting unit 405 selects one thread that is executable by the OS whose execution comes to an end, among the threads waiting to be executed in the multi-processor system. For example, it is assumed that execution of a thread that is assigned to the OS #o1 comes to an end. In this case, the selecting unit 405 selects one thread from among the threads that are executable by the OS #o1.

It is assumed that an OS is detected whose execution of all the threads assigned thereto comes to an end, from the plural OSs. In this case, the selecting unit 405 may select one thread that is executable by the CPU executing the OS whose execution has ended, among the threads waiting to be executed in the multi-processor system. For example, it is assumed that execution of a thread that is assigned to the OS #o2 comes to an end. In this case, the selecting unit 405 selects one thread from among the threads that are executable by the CPU #c2 executing the OS #o2. Selection results are stored in the local memory #lm, etc.

The control unit 406 causes the OS whose execution comes to an end to execute the thread selected by the selecting unit 405. For example, the control unit 406 causes the OS #o1 whose execution of the threads comes to an end to execute the thread #t2.

FIG. 5 is an explanatory diagram of an example of the contents of the thread and OS correlation table. The thread and OS correlation table 411 stores information correlating a thread with an OS for each operation mode.

The thread and OS correlation table 411 depicted in FIG. 5 includes a thread and OS correlation table 501-1 for a view mode before shooting and a thread and OS correlation table 501-2 for a still image shooting mode. The thread and OS correlation table 411 depicted in FIG. 5 further includes thread and OS correlation tables 501-3 and 501-4 respectively for a moving image shooting mode and a moving image reproduction mode. Though not depicted in FIG. 5, the thread and OS correlation table 411 also includes a thread and OS correlation table 501-x in another mode. “x” is a positive integer.

The thread and OS correlation tables for the modes include same fields. For simplification of the description, the thread and OS correlation table 501-1 for the view mode before shooting will be described.

The thread and OS correlation table 501-1 for the view mode before shooting stores records 501-1-1 to 501-1-10 and includes two fields for the thread ID and the OS. The thread ID field stores identification information that is used to identify a thread. The OS field stores identification information of the OS to which the thread stored in the thread field belongs. For example, the record 501-1-1 indicates that the thread #t1 belongs to the OS #o2.

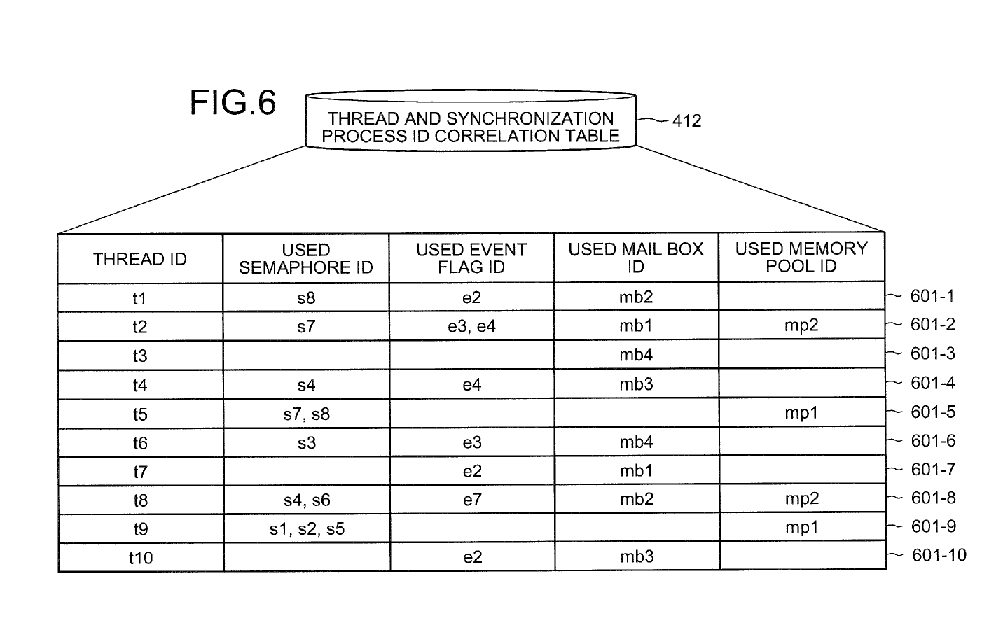

FIG. 6 is an explanatory diagram of an example of the contents of the thread and synchronization process ID correlation table. The thread and synchronization process ID correlation table 412 stores for each thread, the synchronization process used by the thread. The thread and synchronization process ID correlation table 412 depicted in FIG. 6 stores records 601-1 to 601-10.

The thread and synchronization process ID correlation table 412 includes five fields for the thread ID, the used semaphore ID, the used event flag ID, the used mail box ID, and the used memory pool ID. The thread ID field stores identification information that is used to identify a thread. The semaphore ID field stores identification information of a semaphore that is used by the thread stored in the thread field. The event flag ID field stores identification information of an event flag that is used by the thread stored in the thread field. The mail box ID field stores identification information of a mail box that is used by the thread stored in the thread field. The memory pool ID field stores identification information of a memory pool that is used by the thread stored in the thread field.

For example, the record 601-2 indicates that the thread #t2 uses a semaphore ID #s7, event flag IDs #e3 and #e4, a mail box ID #mb1, and a memory pool ID #mp2.

FIG. 7 is an explanatory diagram of an example of the contents of the synchronization process ID and OS correlation table. The synchronization process ID and OS correlation table 413 stores for each synchronization process, an OS to which the thread using the synchronization process belongs. The synchronization process ID and OS correlation table 413 depicted in FIG. 7 includes a semaphore ID and OS correlation table 701-1 and an event flag ID and OS correlation table 701-2 and also includes a mail box ID and OS correlation table 701-3 and a mail pool ID and OS correlation table 701-4. Hereinafter, for simplification of description, the semaphore ID and OS correlation table 701-1 will be described.

The semaphore ID and OS correlation table 701-1 depicted in FIG. 7 has records 701-1-1 to 701-1-8 stored therein. The semaphore ID and OS correlation table 701-1 includes two fields for the semaphore ID and the OS to which the used thread belongs. The semaphore ID field stores identification information of the semaphore. The OS field stores identification information of the OS to which the thread using the corresponding semaphore belongs.

For example, the record 701-1-1 indicates that the semaphore ID #s1 is used by a thread that belongs to the OSs #o1 and #o2.

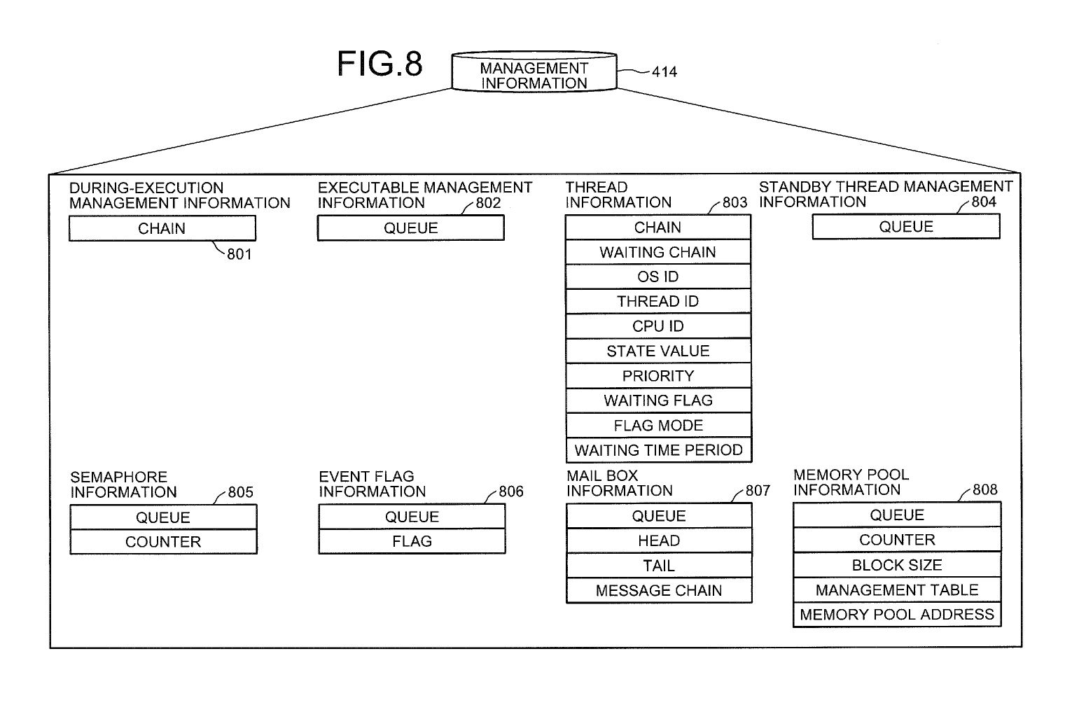

FIG. 8 is an explanatory diagram of an example of the contents of the management information. The management information 414 includes during-execution management information 801, executable management information 802, thread information 803, standby thread management information 804, semaphore information 805, event flag information 806, mail box information 807, and memory pool information 808.

The during-execution management information 801 indicates for each CPU, the threads under execution by the CPU and is formed by data items of a quantity equivalent to the number of CPUs. A chain element of the during-execution management information 801 stores a pointer to the thread information 803 of a thread under execution.

The executable management information 802 indicates an executable thread group and is formed by a single data item. A waiting queue element of the executable management information 802 is a unidirectional list of executable thread information 803 arranged one after another.

The thread information 803 indicates for each thread, an attribute of the thread and is formed by data items of a quantity equivalent to the number of the threads. To identify the data items of thread information 803, the OS control app 101 indexes the data items using the thread IDs. The chain element of the thread information 803 is coupled with information other than the standby thread management information 804 of the management information 414.

When a waiting time period chain element of the thread information 803 realizes a time out, the chain element links from the waiting queue element of the standby thread management information 804. A OS ID element of the thread information 803 represents the identification information of the OS that currently executes the thread. The thread ID element of the thread information 803 is the identification information of the thread. A CPU ID element of the thread information 803 represents the identification information of the CPU that currently executes the thread.

A state value element of the thread information 803 indicates the state of a thread. The state values of the thread information 803 includes an execution state, an executable state, a waiting state (a time period, a semaphore, an event, a mail box, and a memory pool), and an unregistered state. A priority element of the thread information 803 is a value that indicates the priority level of the thread. A waiting flag element and a flag mode element of the thread information 803 store conditions during the waiting time period for the event flag. The waiting time period element of the thread information 803 represents a recovery time period during the waiting time period.

The standby thread management information 804 indicates a thread that is standing by and is formed by a single data item. The thread information 803 data items respectively corresponding to the threads waiting for the time period are arranged one after another by the waiting queue element. The waiting time period is stored in the waiting time period element in the thread information 803.

The semaphore information 805 is formed by data items of a quantity equivalent to the number of semaphores. To identify the data items of the semaphore information 805, the OS control app 101 indexes the data items using the semaphore IDs. The thread information 803 data items respectively corresponding to the threads waiting for acquisition of the semaphore are arranged one after another by the waiting queue element of the semaphore information 805. A counter element of the semaphore information 805 indicates the number of unassigned resources. When the value of the counter element of the semaphore information 805 is “0”, this indicates a state where no resource is available.

The event flag information 806 is formed by data items of a quantity equivalent to the number of events. To identify the data items of the event flag information 806, the OS control app 101 indexes the data items using the event flag IDs. The thread information 803 data items respectively corresponding to the threads each waiting for the event flag are arranged one after another by the waiting queue element of the event flag information 806. The event-waiting condition is stored in the waiting flag element and the flag mode element in the thread information 803. The flag element of the event flag information 806 is the value of the current event flag.

The mail box information 807 is formed by data items of a quantity equivalent to the number of mail boxes. To identify the data items of the mail box information 807, the OS control app 101 indexes the data items using the mail box IDs. The thread information 803 data items respectively corresponding to the threads each waiting for the mail are arranged one after another by the waiting queue element of the mail box information 807. The elements at the head and the tail of the mail box information 807 respectively represent the positions of the head and the tail of the message buffer that starts with the message chain element.

The memory pool information 808 is formed of data items of a quantity corresponding to the number of memory pools. To identify the data items of memory pool information 808, the OS control app 101 indexes the data items using the memory pool IDs. The thread information 803 data items respectively corresponding to the threads each waiting for acquisition of the memory pool are arranged one after another by the waiting queue element of the memory pool information 808. The counter element of the memory pool information 808 is the value of the number of the largest memory blocks. A block size element of the memory pool information 808 indicates the memory size that can be acquired in one acquisition session of the memory pool. A management table element of the memory pool information 808 indicates the use state of the memory block. The memory pool address element of the memory pool information 808 indicates the address at the head of the memory pool.

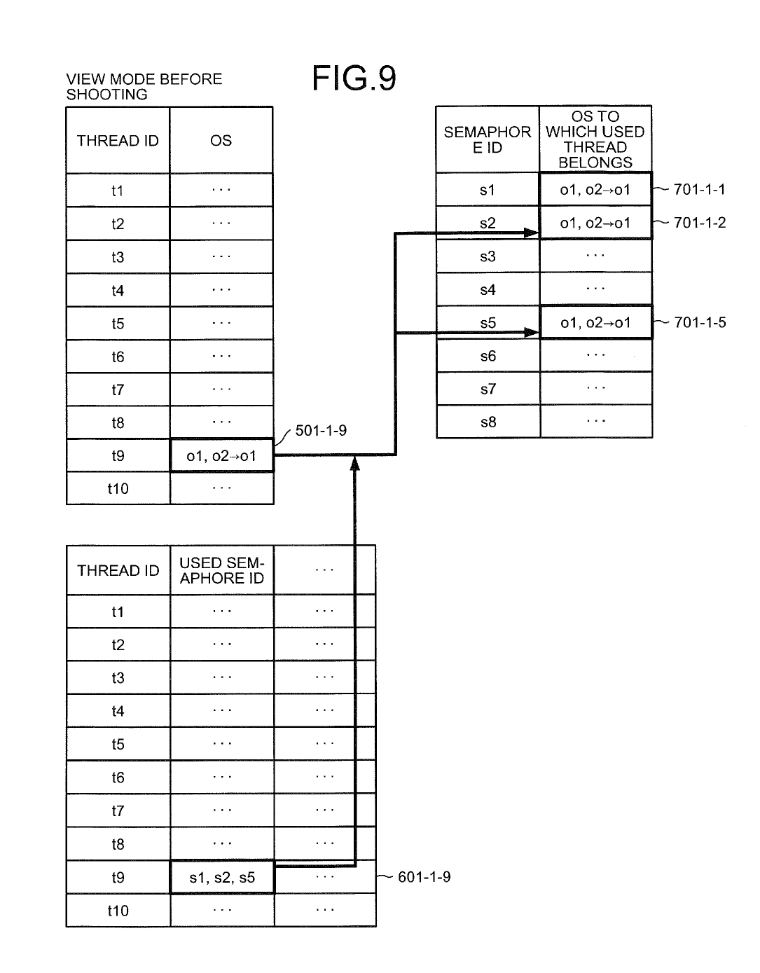

FIG. 9 is an explanatory diagram of an example of updating of the synchronization process ID and OS correlation table. FIG. 9 depicts an example where the synchronization process ID and OS correlation table 413 is updated according to the result of the assignment of the threads.

For example, it is assumed that the record 701-1-1 before the updating indicates that the semaphore ID #s1 is used by the threads belonging to the OSs #o1 and #o2. In this state, it is assumed that the multi-processor system 100 is in the state where the threads #t1 to #t10 are assigned to the OSs #o1 to #o3 for a predetermined time period; and as a result, the thread #t9 is not assigned to the OS #o2 and is assigned to the OS #o1. The “predetermined time period” is a time period that is designated by the development engineer of the multi-processor system 100 and is, for example, one second. In this state, it is assumed that the multi-processor system 100 assigns the threads #t1 to #t10 to the OSs #o1 to #o3 for the predetermined time period and as a result, the thread #t9 is not assigned to the OS #o2 and is assigned to the OS #o1. In this case, the multi-processor system 100 updates the value of the OS field of the record 501-1-9, from “o1 and o2” to “o1”.

The multi-processor system 100, by referring to the record 601-9, identifies the semaphore IDs used by the thread #t9 as the semaphore IDs #s1, #s2, and #s5; and updates the records 701-1-1, 701-1-2, and 701-1-5 for the semaphore IDs #s1, #s2, and #s5, in the synchronization process ID and OS correlation table 413. For example, for the record 701-1-1, the multi-processor system 100 updates the value of the OS field of the OS to which the used thread in the record 701-1-1 belongs, from “o1 and o2” to “o1”. In this manner, when the OSs to which used threads belong becomes one OS for the synchronization process, the multi-processor system 100 does not have to execute any synchronization process for the OSs and therefore, the processing performance of the multi-processor system 100 can be improved.

When the synchronization process ID and OS correlation table 413 is updated, the multi-processor system 100 may prepare two tables, one to be used by being referred to in actual operation and one to be used for updating. When the updating is executed, the multi-processor system 100 prepares as a table to be used for the updating, a table formed by duplicating the table to be used by being referred to in actual operation; and executes an updating process for the table to be used for the updating.

An updating amount of the thread and OS correlation table 411 will be described. When the multi-processor system 100 is a digital camera, operation modes include the view mode before shooting, the still image shooting mode, a still image reproduction mode, a moving image shooting mode, a moving image reproduction mode, a sound recording mode, a sound reproduction mode, a USB connection mode, a printer connection mode, etc. The thread and OS correlation table 411 is prepared for each of these operations modes. However, the thread actually executed may be changed due to an additional setting made by the user. Additional settings made by the user include a face detection setting, a smile detection setting, a enhanced skin setting, a dynamic object detection setting, a dynamic object tracking setting, a scene detection setting, a camera shake correction setting, etc.

Therefore, the multi-processor system 100 updates fifty percent or more of the thread and OS correlation table 411 as the amount subject to updating. Therefore, the execution of the updating enables the multi-processor system 100 to significantly reduce the opportunities to use the global memory #gm.

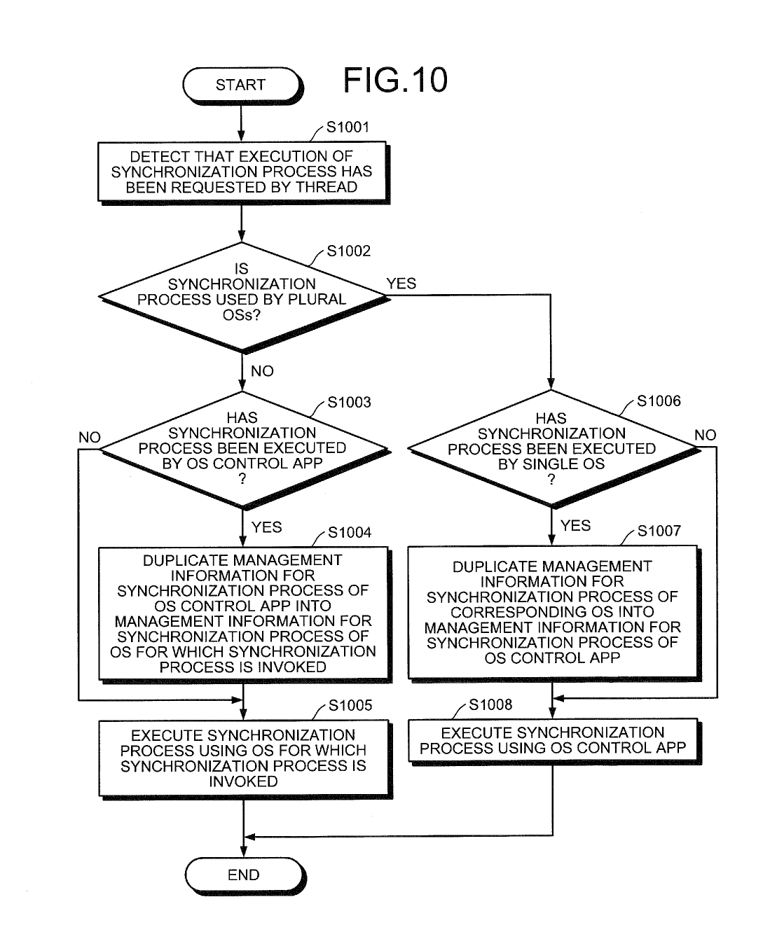

An executing entity determination process for the synchronization process, and updating processes for the thread and OS correlation table 411 and the synchronization process ID and OS correlation table 413 will be described with reference to FIGS. 10 to 12. Each of these processes may be executed by any one of the CPUs #c1 to #c6. For simplification of description, in the embodiment, description will be made taking an example of a case where the CPU #c1 executes the processes.

FIG. 10 is a flowchart of an example of a procedure for the executing entity determination process for the synchronization process. The executing entity determination process for the synchronization process is a process of determining whether the executing entity that is to execute the synchronization process is to be the OS for which the synchronization process is invoked or the OS control app 101; and causing the determined executing entity to execute the synchronization process.

The CPU #c1 detects that execution of a synchronization process has been requested by a thread (step S1001), and by referring to the synchronization process ID and OS correlation table 413, determines whether the synchronization process is used by plural OSs (step S1002). The “synchronization process” refers to the synchronization process that is invoked by the thread. If the CPU #c1 determines that the synchronization process is used by a single OS (step S1002: NO), the CPU #c1 determines whether the synchronization process has been executed by the OS control app 101 (step S1003).

If the CPU #c1 determines that the synchronization process has been executed by the OS control app 101 (step S1003: YES), the CPU #c1 duplicates the management information 414 for the synchronization process of the OS control app 101 into the management information for the synchronization process of the OS for which the synchronization process is invoked (step S1004). The management information for the synchronization process of the OS for which the synchronization process is invoked is stored to the local memory #lm1 if the OS for which the synchronization process is invoked is the OS #o1. The management information is stored to the shared memory #sm2 if the OS for which the synchronization process is invoked is the OS #o2. The management information is stored to the shared memory #sm3 if the OS for which the synchronization process is invoked is the OS #o3. After the operation at step S1004 comes to an end, or if the CPU #c1 determines that the synchronization process has been executed by a single OS (step S1003: NO), the CPU #c1 executes the synchronization process using the OS for which the synchronization process is invoked (step S1005).

If the CPU #c1 determines that the synchronization process is used by plural OSs (step S1002: YES), the CPU #c1 determines whether the synchronization process has been executed by a single OS (step S1006). If the CPU #c1 determines that the synchronization process has been executed by a single OS (step S1006: YES), the CPU #c1 duplicates the management information for the synchronization process of the corresponding OS into the management information 414 for the synchronization process of the OS control app 101 (step S1007). After the operation at step S1007 comes to an end, or if the CPU #c1 determines that the synchronization process has been executed by the OS control app 101 (step S1006: NO), the CPU #c1 executes the synchronization process using the OS control app 101 (step S1008). Detailed processing contents of the synchronization process executed by the OS control app 101 is same as that executed by the OS and therefore, will not again be described.

After the execution of the operation at step S1005 or S1008 comes to an end, the CPU #c1 causes the executing entity determination process for the synchronization process to come to an end. If the synchronization process is used by the single OS, the CPU #c1 executes the synchronization process using the local memory #lm and the CPUs #c2 to #c6 execute the synchronization process using the shared memory #sm. Therefore, if the synchronization process is used by the single OS, the multi-processor system 100 does not use the global memory #gm and consequently, the performance of the multi-processor system 100 can be improved.

The CPU #c1 may omit the operations at steps S1003, S1004, S1006, and S1007. If the CPU #c1 does not execute the operations at steps S1003, S1004, S1006, and S1007, the CPU #c1 only has to execute the operation at step S1005 or S1008 after the CPU #c1 releases the use of the synchronization process. If release of the use of the synchronization process is difficult, the CPU #c1 can switch the executing entity of the synchronization process to continue the use of the synchronization process, by executing the operations at steps S1003, S1004, S1006, and S1007.

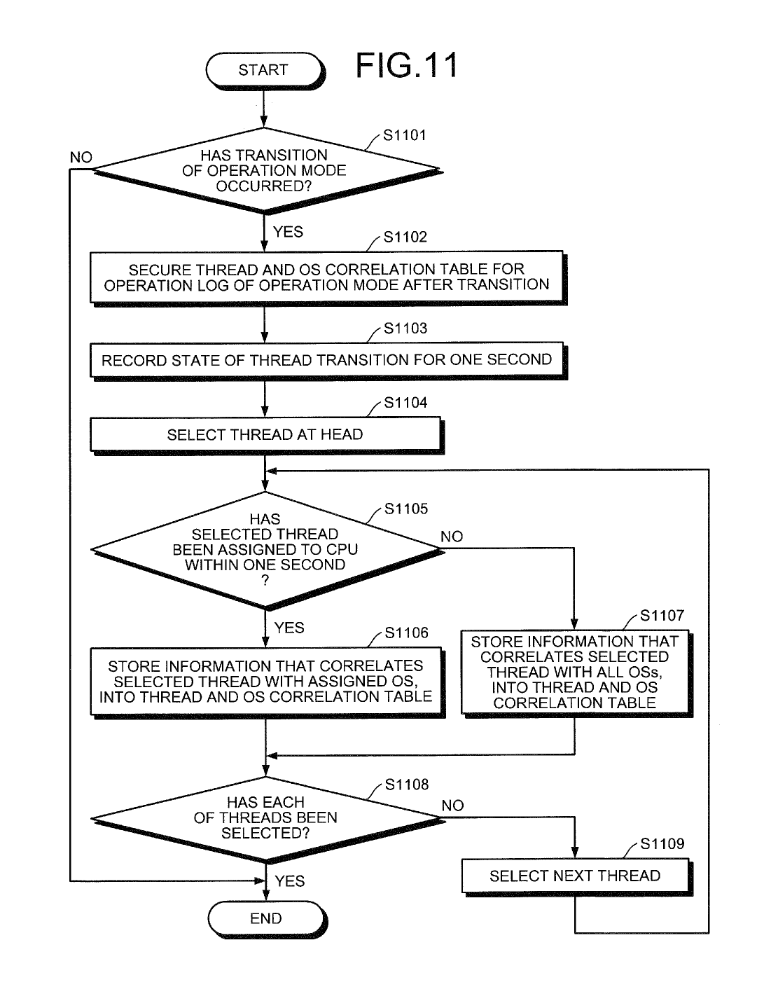

FIG. 11 is a flowchart of an example of a procedure for an updating process for the thread and OS correlation table. The updating process for the thread and OS correlation table is a process of updating the thread and OS correlation table 411 according to the assignment state of the threads.

The CPU #c1 determines whether transition of the operation mode has occurred (step S1101). If the CPU #c1 determines that a transition of the operation mode has occurred (step S1101: YES), the CPU #c1 secures the thread and OS correlation table 501-x for the operation log of the operation mode after the transition (step S1102), records the state of the thread transition for one second as the predetermined time period (step S1103), and selects the thread at the head (step S1104).

The CPU #c1 determines whether the selected thread has been assigned to a CPU within the one second (step S1105). If the CPU #c1 determines that the selected thread has been assigned to a CPU (step S1105: YES), the CPU #c1 stores information that correlates the selected thread with the assigned OS, into the thread and OS correlation table 501-x (step S1106).

If the CPU #c1 determines that the selected thread has not been assigned to a CPU (step S1105: NO), the CPU #c1 stores information that correlates the selected thread with all the OSs, into the thread and OS correlation table 501-x (step S1107).

After the operation at step S1106 or S1107 comes to an end, the CPU #c1 determines whether each of the threads has been selected (step S1108). If the CPU #c1 determines that unselected threads remain (step S1108: NO), the CPU #c1 selects the next thread (step S1109). After the execution of the operation at step S1109 comes to an end, the CPU #c1 advances to the operation at step S1105. If the CPU #c1 determines that no transition of the operation mode has occurred (step S1101: NO) or if the CPU #c1 determines that each of the threads has been selected (step S1108: YES), the CPU #c1 causes the updating process for the thread and OS correlation table to come to an end. The execution of the updating process for the thread and OS correlation table enables the multi-processor system 100 to produce the information to be used to facilitate the reduction of the execution frequency of executing the synchronization process for the plural OSs.

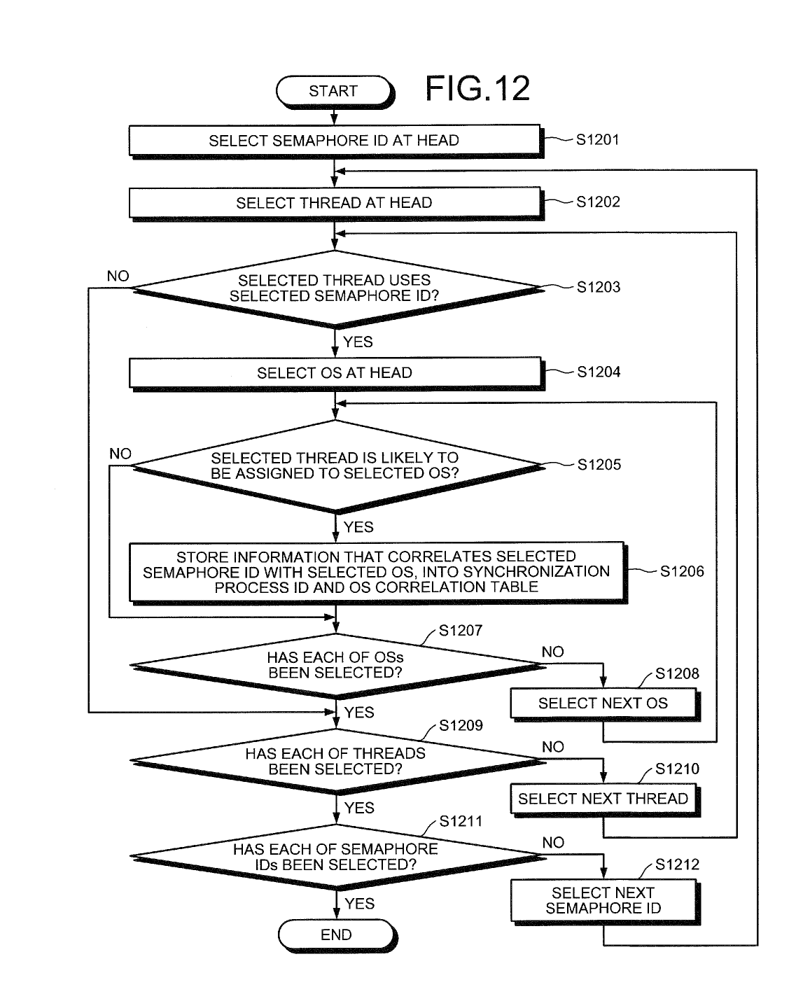

FIG. 12 is a flowchart of an example of a procedure for the updating process for the synchronization process ID and OS correlation table. The updating process for the synchronization process ID and OS correlation table is a process of updating the synchronization process ID and OS correlation table 413 based on the thread and OS correlation table 411, and the thread and synchronization process ID correlation table 412 that are updated as described with reference to FIG. 11. In FIG. 12, for simplification of description, an example will be described where the semaphore ID and OS correlation table 701-1 is updated.

The CPU #c1 selects the semaphore ID at the head (step S1201), selects the thread at the head (step S1202), and by referring to the thread and synchronization process ID correlation table 412, determines whether the selected thread uses the selected semaphore ID (step S1203). If the CPU #c1 determines that the selected thread uses the selected semaphore ID (step S1203: YES), the CPU #c1 selects the OS at the head (step S1204).

The CPU #c1 determines by referring to the thread and OS correlation table 411 that is updated as described with reference to the flowchart in FIG. 11, whether the selected thread is likely to be assigned to the selected OS (step S1205). If the CPU #c1 determines that the selected thread is likely to be assigned to the selected OS (step S1205: YES), the CPU #c1 stores information that correlates the selected semaphore ID with the selected OS, into the synchronization process ID and OS correlation table 413 (step S1206).

After the operation at step S1206 comes to an end or if the CPU #c1 determines that the selected thread is not likely to be assigned to the selected OS (step S1205: NO), the CPU #c1 determines whether each of the OSs has been selected (step S1207). If the CPU #c1 determines that unselected OSs remain (step S1207: NO), the CPU #c1 selects the next OS (step S1208). After the operation at step S1208 comes to an end, the CPU #c1 advances to the operation at step S1205.

If the CPU #c1 determines that the selected thread does not use the selected semaphore ID (step S1203: NO) or if the CPU #c1 determines that each of the OSs has been selected (step S1207: YES), the CPU #c1 determines whether each of the threads has been selected (step S1209). If the CPU #c1 determines that unselected threads remain (step S1209: NO), the CPU #c1 selects the next thread (step S1210). After the operation at step S1210 comes to an end, the CPU #c1 advances to the operation at step S1203.

If the CPU #c1 determines that each of the threads has been selected (step S1209: YES), the CPU #c1 determines whether each of the semaphore IDs has been selected (step S1211). If the CPU #c1 determines that unselected semaphore IDs remain (step S1211: NO), the CPU #c1 selects the next semaphore ID (step S1212). After the operation at step S1212 comes to an end, the CPU #c1 advances to the operation at step S1202.

If the CPU #c1 determines that each of the semaphore IDs has been selected (step S1211: YES), the CPU #c1 causes the updating process for the synchronization process ID and OS correlation table to come to an end. The execution of the updating process for the synchronization process ID and OS correlation table enables the multi-processor system 100 to facilitate reduction of the frequency of executing the synchronization process for the plural OSs.

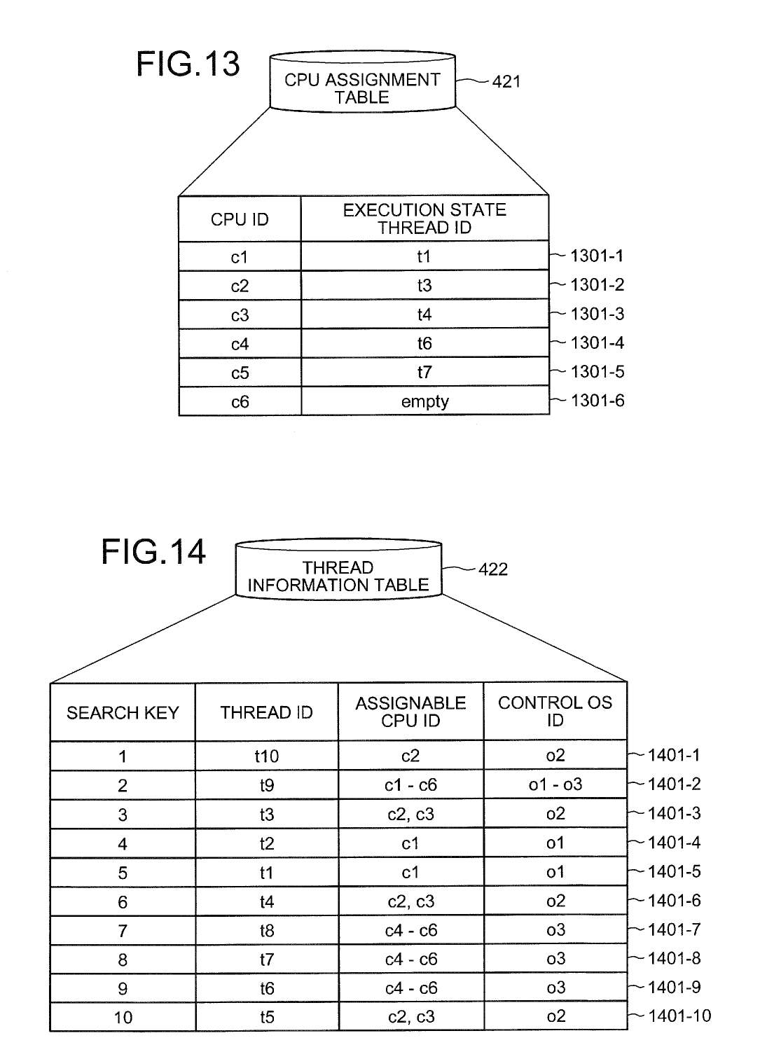

Unified scheduling that is executed by the OS control app 101 when the synchronization process is executed for the plural OSs, will be described with reference to FIGS. 13 to 38. In the unified scheduling, a scheduling method is executed according to the priority level including the process steps such as, for example, assignment of the thread with the highest priority level instead of a thread that is stopped executed when the stopped thread is present.

FIG. 13 is an explanatory diagram of an example of the contents of the CPU assignment table. The CPU assignment table 421 is a table that has the identification information of the under execution thread stored therein. The CPU assignment table 421 depicted in FIG. 13 has records 1301-1 to 1301-6 stored therein. The CPU assignment table 421 includes two fields for the CPU ID and the execution state thread ID. The CPU ID field stores the identification information concerning the CPU. The execution state thread ID field stores the identification information of the thread under execution by the CPU stored in the CPU ID field.

For example, the record 1301-1 represents that the CPU #c1 currently executes the thread #t1. The record 1301-6 represents that the CPU #c6 currently executes no thread.

FIG. 14 is an explanatory diagram of an example of the contents of the thread information table. The thread information table 422 stores for each thread in descending order of priority level of the thread, the CPU IDs of the CPUs that can execute the thread and the OS IDs of the OSs executed by the CPUs. The thread information table 422 depicted in FIG. 14 has records 1401-1 to 1401-10 stored therein.

The thread information table 422 includes four fields for the search key, the thread ID, the assignable CPU ID, and the control OS ID. The search key field stores a value that indicates the search order of the corresponding record. In FIG. 14, a smaller value is stored in the search key field for a record to be searched sooner. The thread ID field stores the identification information of the thread. The assignable CPU ID field stores the identification information of the CPU to which the thread stored in the thread ID field is assignable. The control OS ID field stores the identification information of the OS executed by the CPU stored in the assignable CPU ID field.

For example: the record 1401-1 is searched first and indicates that the thread #t10 is assignable to the CPU #c2 and the CPU #c2 executes the OS #o2; and the record 1401-2 is searched second and indicates that the thread #t9 is assignable to any one of the CPUs #c1 to #c6 and the CPUs #c1 to #c6 execute the OSs #o1 to #o3.

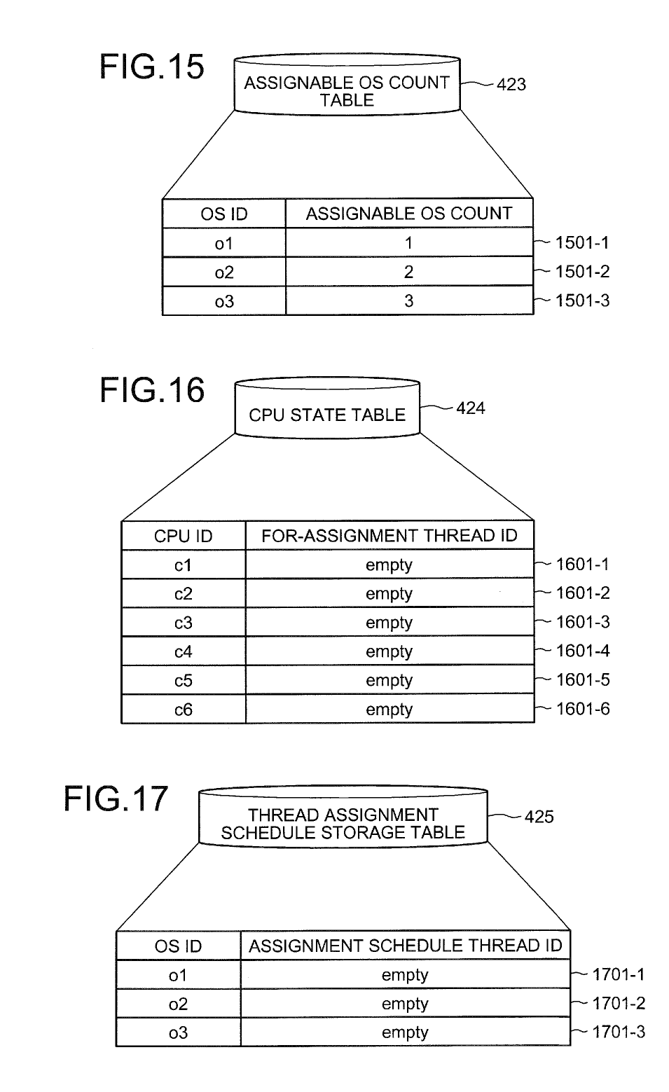

FIG. 15 is an explanatory diagram of an example of the contents of the assignable OS count table. The assignable OS count table 423 is a table that stores for each OS, the number of the CPUs to which no thread is assigned yet. The assignable OS count table 423 depicted in FIG. 15 stores records 1501-1 to 1501-3.

The assignable OS count table 423 includes two fields for the OS ID and the number of assignable OSs. The OS ID field stores the identification information of the OS. The assignable OS number field stores the number of CPUs to which no thread is assigned, among the CPUs each to execute the OS stored in the OS ID field. For example, the record 1501-1 indicates that the number of CPUs to which no thread is assigned is one, among the CPUs each to execute the OS #o1.

FIG. 16 is an explanatory diagram of an example of the contents of the CPU state table. The CPU state table 424 is a table that is used in the search process of the unified scheduling and that stores threads as candidates to be assigned to the CPUs. The CPU state table 424 depicted in FIG. 16 stores records 1601-1 to 1601-6.

The CPU state table 424 includes two fields for the CPU ID and the thread ID for assignment. The CPU ID field stores the identification information of a CPU. The thread ID field stores the identification information of a thread that is a candidate for assignment to the CPU stored in the CPU ID field. If “empty” is stored in the thread ID field, this indicates that no thread is present to be a candidate to be assigned to the CPU stored in the CPU ID field. For example, the record 1601-1 indicates that no thread is present to be a candidate to be assigned to the CPU #c1.

FIG. 17 is an explanatory diagram of an example of the contents of the thread assignment schedule storage table. The thread assignment schedule storage table 425 is a table storing for each OS, a thread that is assignable to the CPU when the CPU is the CPU to execute the OS. The thread assignment schedule storage table 425 depicted in FIG. 17 stores records 1701-1 to 1701-3.

The thread assignment schedule storage table 425 includes two fields, for the OS ID and the thread ID of the thread scheduled to be assigned. The OS ID field stores the identification information of the OS. The thread ID field stores the identification information of the thread that is to be assigned to a CPU when the CPU is the CPU to execute the OS stored in the OS ID field. If “empty” is stored in the thread ID field, this indicates that no thread is present that is assignable to the CPU to execute the corresponding OS. For example, the record 1701-1 indicates that no thread is present that is assignable to a CPU when the CPU executes the OS #o1.

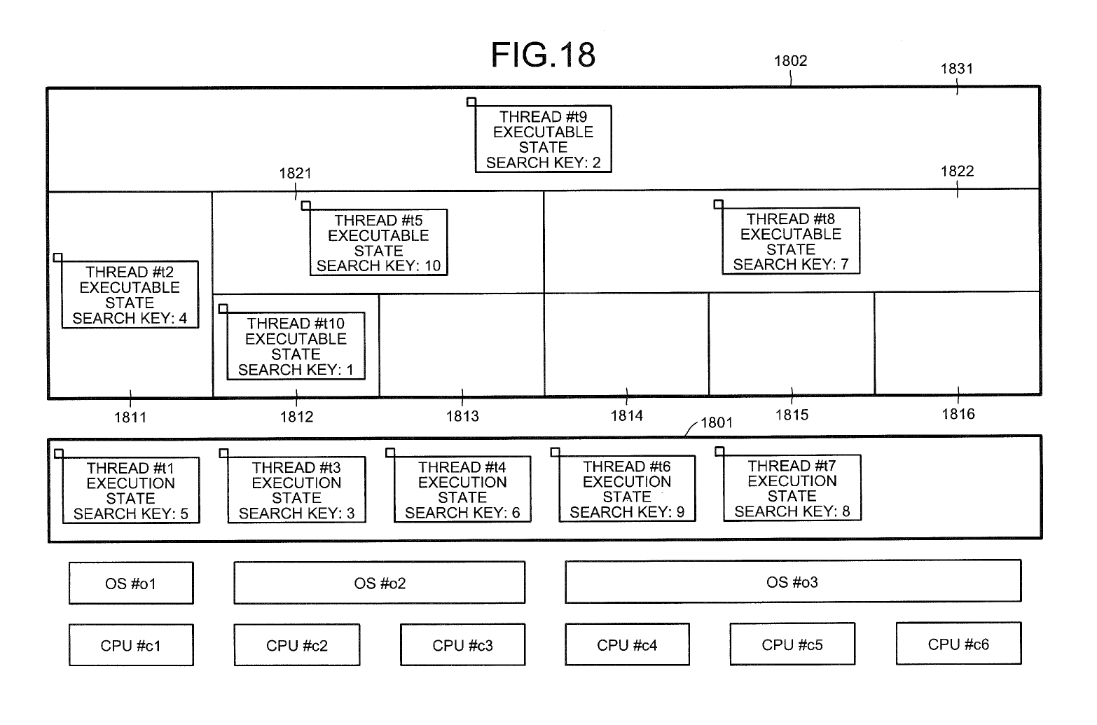

FIG. 18 is an explanatory diagram of an assignment state of the threads before the execution of the unified scheduling. FIG. 18 depicts the state according to the content of the CPU assignment table 421 depicted in FIG. 13 and the content of the thread information table 422 depicted in FIG. 14 as the state before the execution of the unified scheduling. In FIG. 18, the threads are classified using areas 1801 and 1802 based on the state of the thread and, the CPU and the OS to which the thread is assignable.

The area 1801 includes a group of threads in the execution state. The area 1802 includes a group of threads in the executable state and further includes areas 1811 to 1816, 1821, 1822, and 1831 based on the CPUs and the OSs to which the threads are assignable.

The area 1801 includes the threads #t1, #t3, #t4, #t6, and #t7. The threads #t1, #t3, #t4, #t6, and #t7 are respectively assigned to the CPUs #c1 to #c5. No thread is assigned to the CPU #c6.

The areas 1811 to 1816 are areas respectively including the threads assignable to the CPUs #c1, #c2, #c3, #c4, #c5, and #c6. The areas 1811 and 1812 respectively include the threads #t2 and #t10.

The areas 1821 and 1822 are areas that respectively include the threads assignable to the CPUs #c2 and #c3 that execute the OS #o2, and the CPUs #c4 to #c6 that execute the OS #o3; and respectively include the threads #t5 and #t8. The area 1831 is an area that includes the threads assignable to the CPUs #c1 to #c6 and includes the thread #t9.

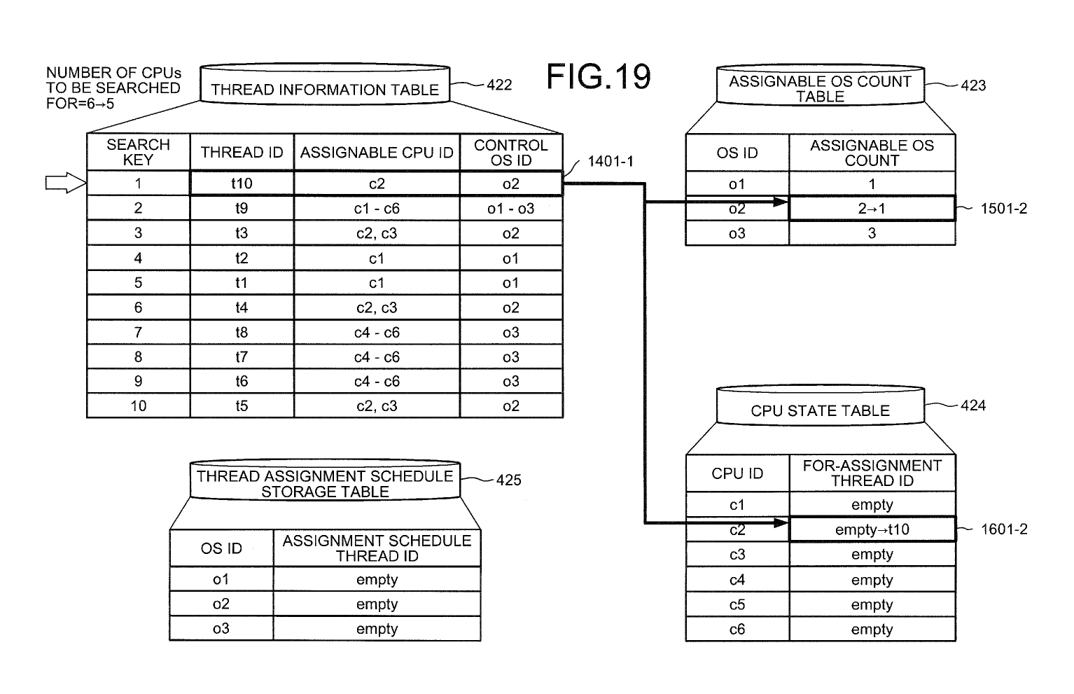

The operation of the search process of the unified scheduling will be described with reference to FIGS. 19 to 27. The search process of the unified scheduling is a process of searching for and retrieving for each CPU, threads to be candidates to be assigned to the CPU. The processing of the unified scheduling may be executed by any one of the CPUs #c1 to #c6. For simplification of description, in the embodiment, description will be made taking an example of a case where the CPU #c1 executes the processing of the unified scheduling.

FIG. 19 is an explanatory diagram of a first stage of the search process of the unified scheduling. In the state depicted in FIG. 19, the number of CPUs to be searched for is six. In this state, the CPU #c1 selects the record 1401-1 that is the first record of the thread information table 422. The CPU #c1 identifies the CPU #c2 from the assignable CPU ID field of the record 1401-1; further identifies the record 1601-2 that is the record for the CPU #c2 of the CPU state table 424; and stores the identification information “t10” of the thread #t10 into the thread ID field of the record 1601-2 because this field has “empty” stored therein. Because the one thread is assigned to the OS #o2, the CPU #c1 changes the record 1501-2 of the assignable OS count table 423 from “2” to “1”. In FIG. 19, the CPU #c2 is retrieved and therefore, the CPU #c1 sets the number of CPUs to be retrieved to be five.

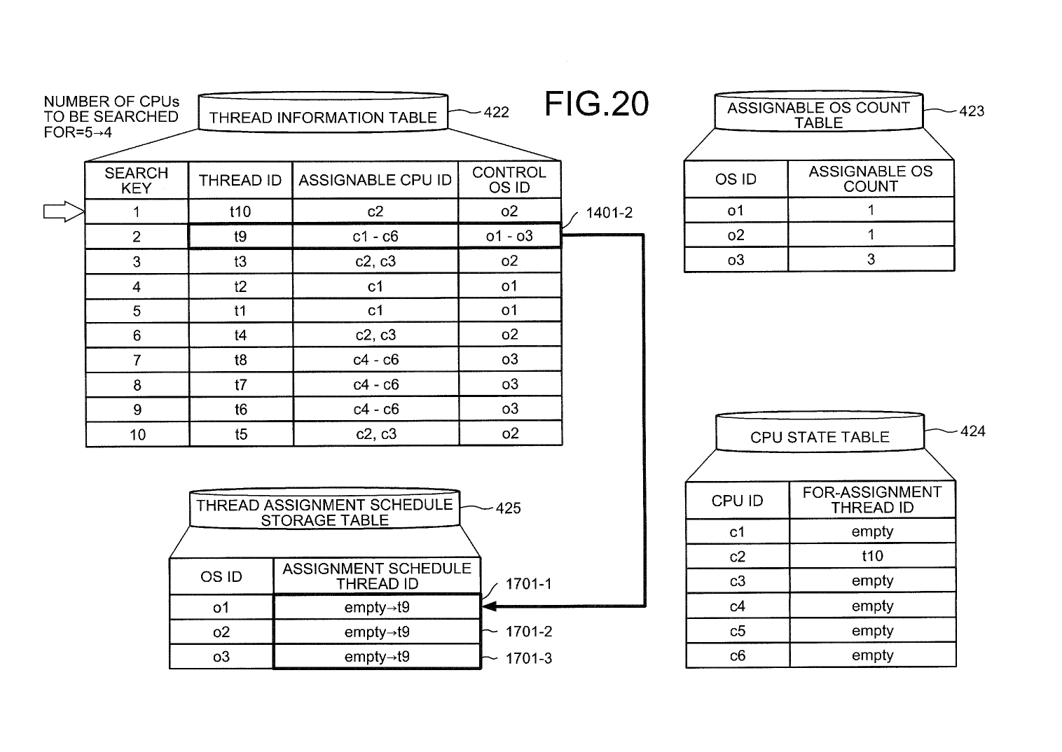

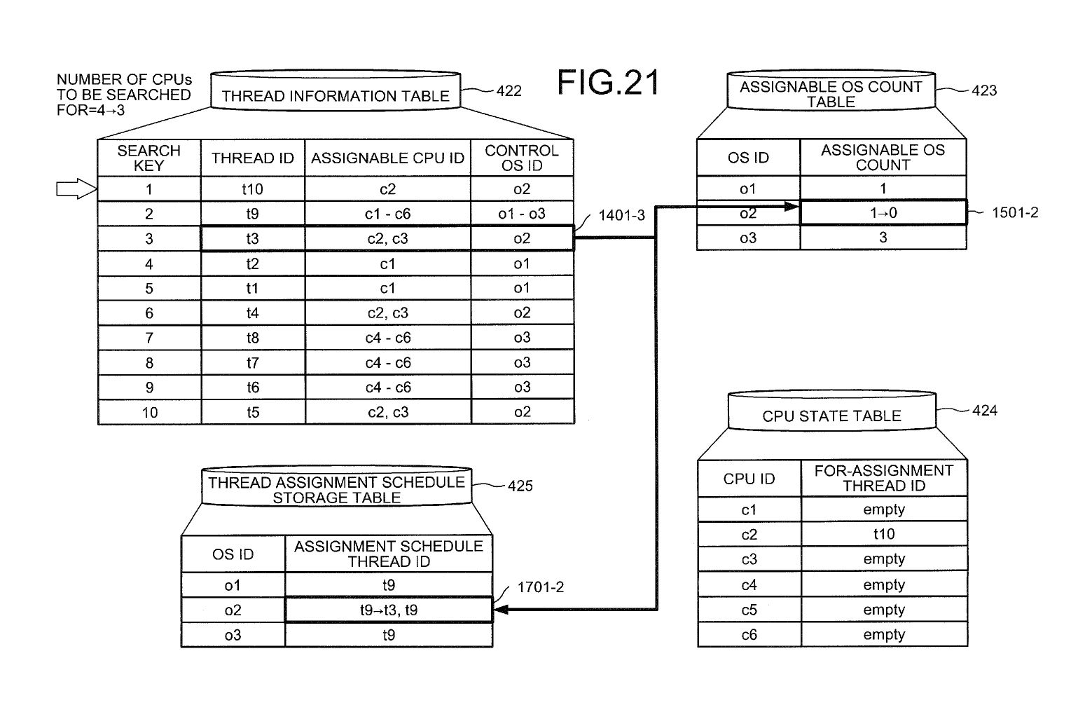

FIG. 20 is an explanatory diagram of a second stage of the search process of the unified scheduling. In the state depicted in FIG. 20, the number of CPUs to be retrieved is five. In this state, the CPU #c1 selects the record 1401-2 that is the second record of the thread information table 422, and identifies the CPUs #c1 to #c6 from the assignable CPU ID field of the record 1401-2. As indicated by the record 1401-2, the thread #t9 is executable by plural CPUs and therefore, the CPU #c1 adds information of the thread #t9 to the thread assignment schedule storage table 425. For example, the CPU #c1 changes “empty”, to “t9”, in each of the records 1701-1 to 1701-3 of the thread assignment schedule storage table 425.

Because the thread #t9 is operable by plural OSs, the CPU #c1 does not update the assignable OS count table 423 and further sets the number of CPUs to be retrieved to be four.

FIG. 21 is an explanatory diagram of a third stage of the search process of the unified scheduling. In the state depicted in FIG. 21, the number of CPUs to be retrieved is four. In this state, the CPU #c1 selects the record 1401-3 that is the third record of the thread information table 422 and identifies the CPUs #c2 and #c3 from the assignable CPU ID field of the record 1401-3. As indicated by the record 1401-3, the thread #t3 is executable by plural CPUs and therefore, the CPU #c1 adds information of the thread #t3 to the thread assignment schedule storage table 425. For example, the CPU #c1 changes “t9”, to “t3 and t9”, in the record 1701-2 of the thread assignment schedule storage table 425.

Because the one thread is assigned to the OS #o2, the CPU #c1 changes the record 1501-2 of the assignable OS count table 423 from “1” to “0” and sets the number of CPUs to be retrieved to be three.

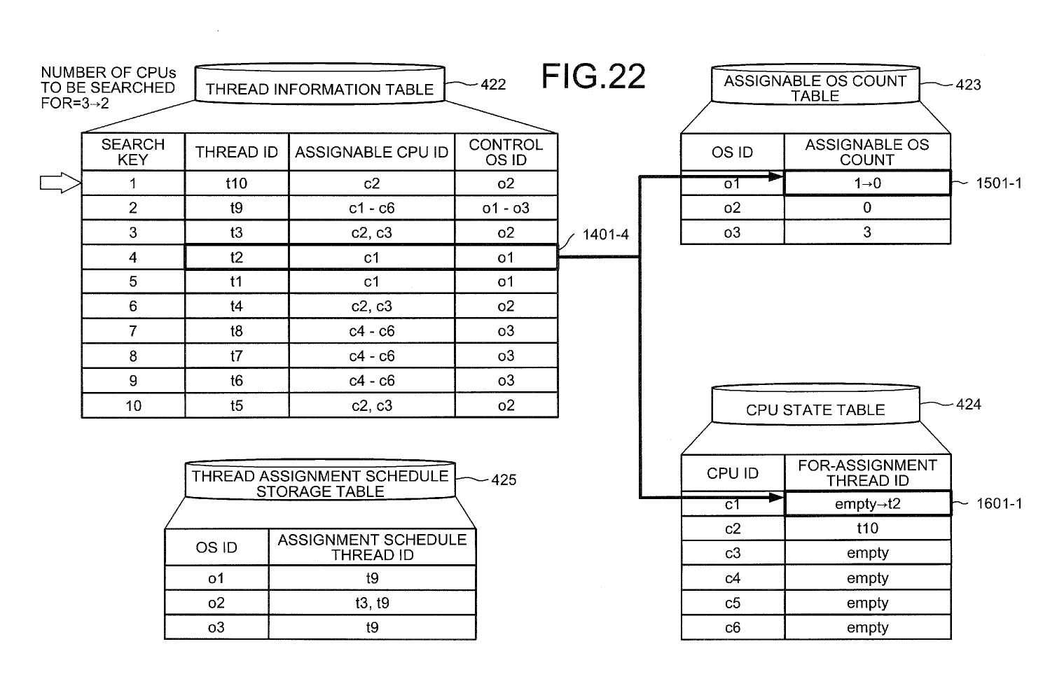

FIG. 22 is an explanatory diagram of a fourth stage of the search process of the unified scheduling. In the state depicted in FIG. 22, the number of CPUs to be retrieved is three. In this state, the CPU #c1 selects the record 1401-4 that is the fourth record of the thread information table 422; identifies the CPU #c1 from the assignable CPU ID field of the record 1401-4; identifies the record 1601-1 that is the record of the CPU #c1 of the CPU state table 424; stores the identification information “t2” of the thread #t2 into the thread ID field of the record 1601-1 because this field has “empty” stored therein; and changes the record 1501-1 of the assignable OS count table 423 from “1” to “0” because the one thread is assigned to the OS #o1. In FIG. 22, the CPU #c1 is retrieved and therefore, the CPU #c1 sets the number of CPUs to be retrieved to be two.

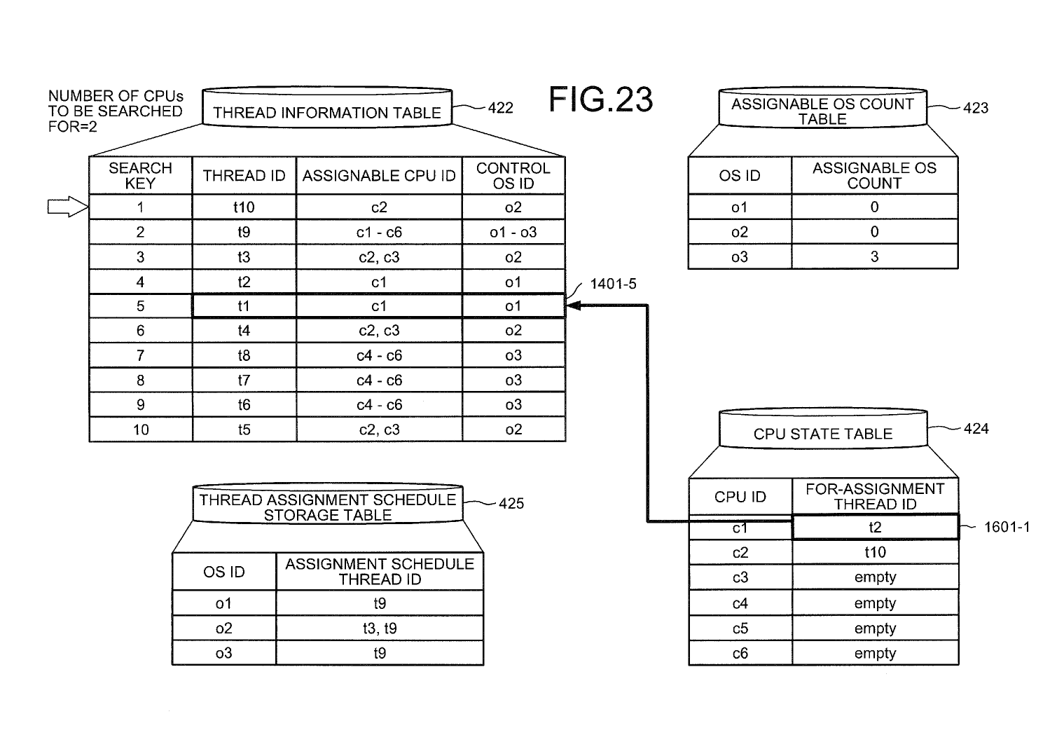

FIG. 23 is an explanatory diagram of a fifth stage of the search process of the unified scheduling. In the state depicted in FIG. 23, the number of CPUs to be retrieved is two. In this state, the CPU #c1 selects the record 1401-5 that is the fifth record of the thread information table 422; identifies the CPU #c1 from the assignable CPU ID field of the record 1401-5; identifies the record 1601-1 that is the record of the CPU #c1 of the CPU state table 424; and does not set the thread #t1 to be a candidate for assignment because the thread ID field of the record 1601-1 has “t2” stored therein and a candidate thread to be assigned is already present.

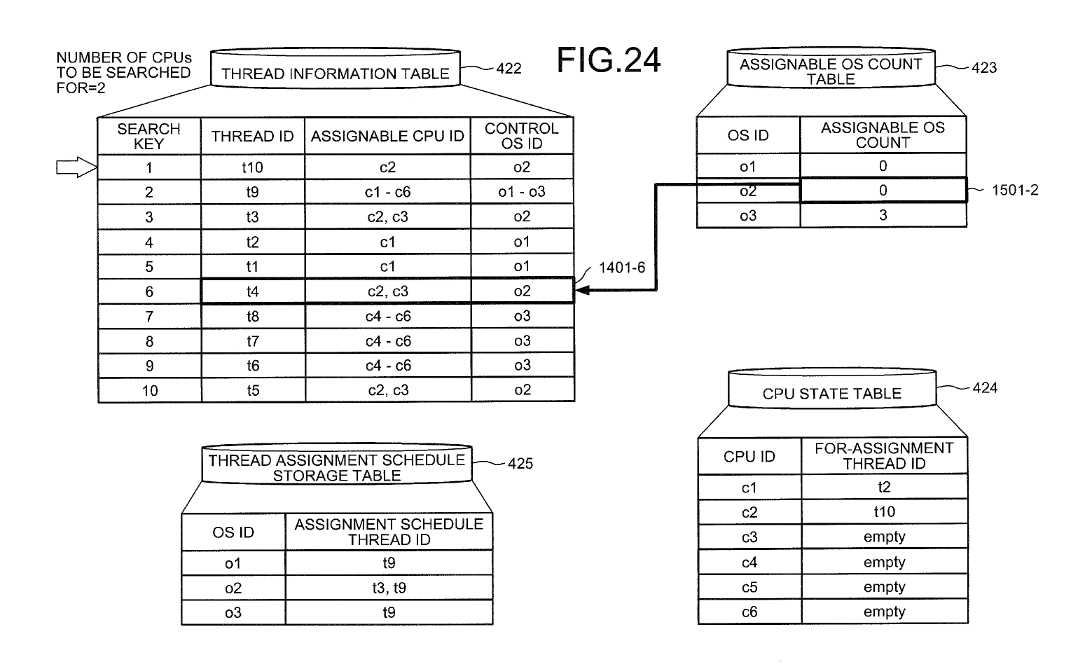

FIG. 24 is an explanatory diagram of a sixth stage of the search process of the unified scheduling. In the state depicted in FIG. 24, the number of CPUs to be retrieved is two. In this state, the CPU #c1 selects the record 1401-6 that is the sixth record of the thread information table 422; and identifies the CPUs #c2 and #c3 from the assignable CPU ID field of the record 1401-6. As indicated by the record 1401-6, the thread #t4 is executable by the plural CPUs. However, for the OS #o2 that is to execute the thread #t4, the number of assignable OSs is zero as indicated by the record 1501-2 of the assignable OS count table 423 and therefore, the CPU #c1 does not set the thread #t5 to be a candidate for assignment.

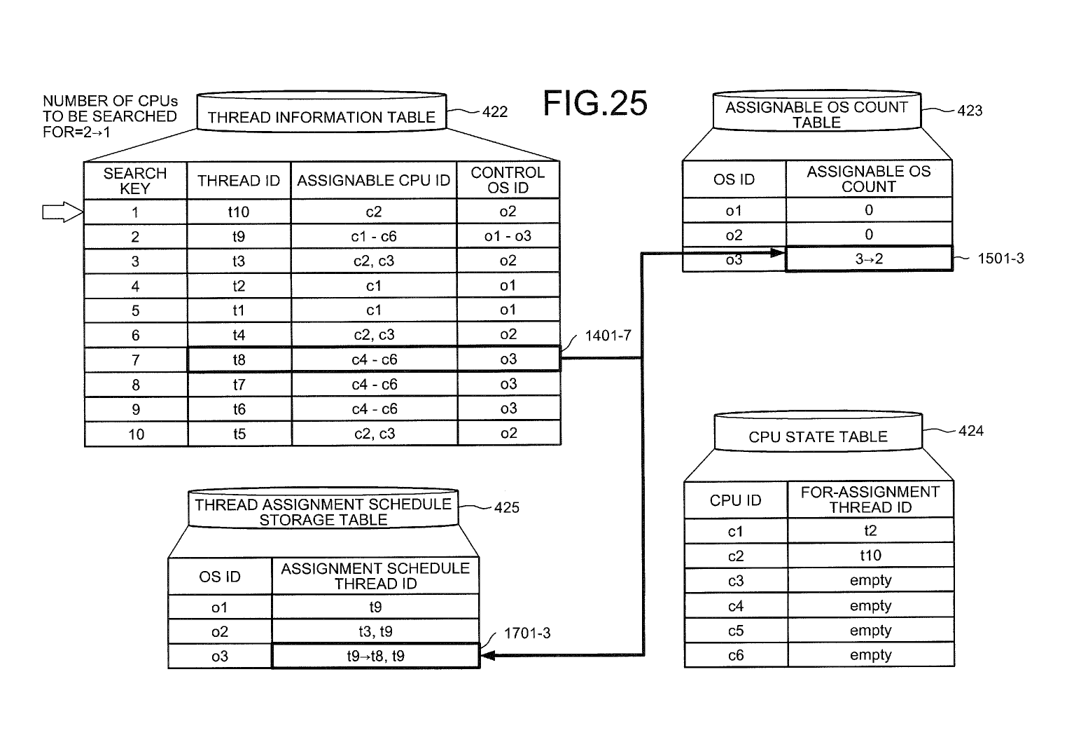

FIG. 25 is an explanatory diagram of a seventh stage of the search process of the unified scheduling. In the state depicted in FIG. 25, the number of CPUs to be retrieved is two. In this state, the CPU #c1 selects the record 1401-7 that is the seventh record of the thread information table 422; and identifies the CPUs #c4 to #c6 from the assignable CPU ID field of the record 1401-7. As indicated by the record 1401-7, the thread #t8 is executable by plural CPUs and therefore, the CPU #c1 adds information of the thread #t8 to the thread assignment schedule storage table 425. For example, the CPU #c1 changes “t9”, to “t8 and t9”, in the record 1701-3 of the thread assignment schedule storage table 425.

Because the one thread is assigned to the OS #o3, the CPU #c1 changes the record 1501-3 of the assignable OS count table 423 from “3” to “2” and sets the number of CPUs to be retrieved to be one.

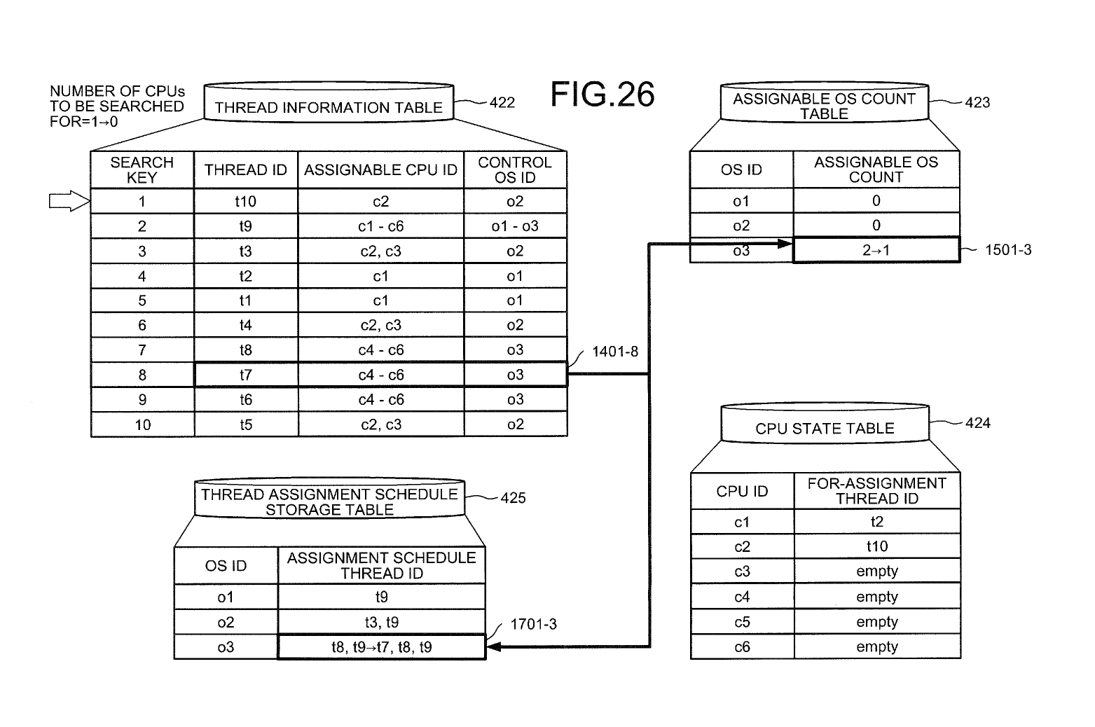

FIG. 26 is an explanatory diagram of an eighth stage of the search process of the unified scheduling. In the state depicted in FIG. 26, the number of CPUs to be retrieved is one. In this state, the CPU #c1 selects the record 1401-8 that is the eighth record of the thread information table 422; and identifies the CPUs #c4 to #c6 from the assignable CPU ID field of the record 1401-8. As indicated by the record 1401-8, the thread #t7 is executable by plural CPUs and therefore, the CPU #c1 adds information of the thread #t7 to the thread assignment schedule storage table 425. For example, the CPU #c1 changes “t8 and t9”, to “t7 to t9”, in the record 1701-3 of the thread assignment schedule storage table 425.

Because the one thread is assigned to the OS #o3, the CPU #c1 changes the record 1501-3 of the assignable OS count table 423 from “2” to “1” and sets the number of CPUs to be retrieved to be zero.

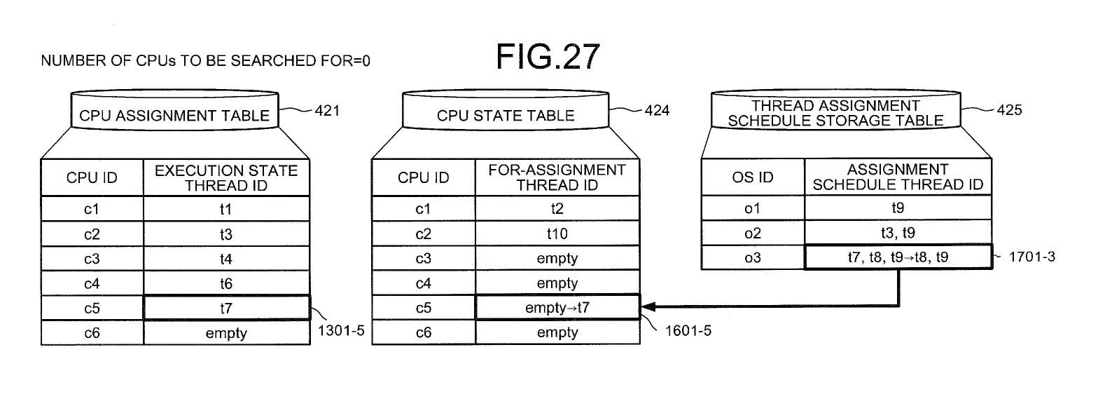

FIG. 27 is an explanatory diagram of a ninth stage of the search process of the unified scheduling. The CPU #c1 sets the threads that are already registered in the CPU assignment table 421 and whose assignment destination does not have to be changed to another CPU, to be already assigned threads, among the threads registered in the thread assignment schedule storage table 425. In the example depicted in FIG. 27, the thread #t7 is registered in the record 1301-5 of the CPU assignment table 421 and the assignment destination thereof does not have to be changed to another CPU and therefore, the CPU #c1 changes the record 1601-5 of the CPU state table 424 from “empty” to “t7”, and also changes the record 1701-3 of the thread assignment schedule storage table 425 from “t7 to t9” to “t8 and t9”.

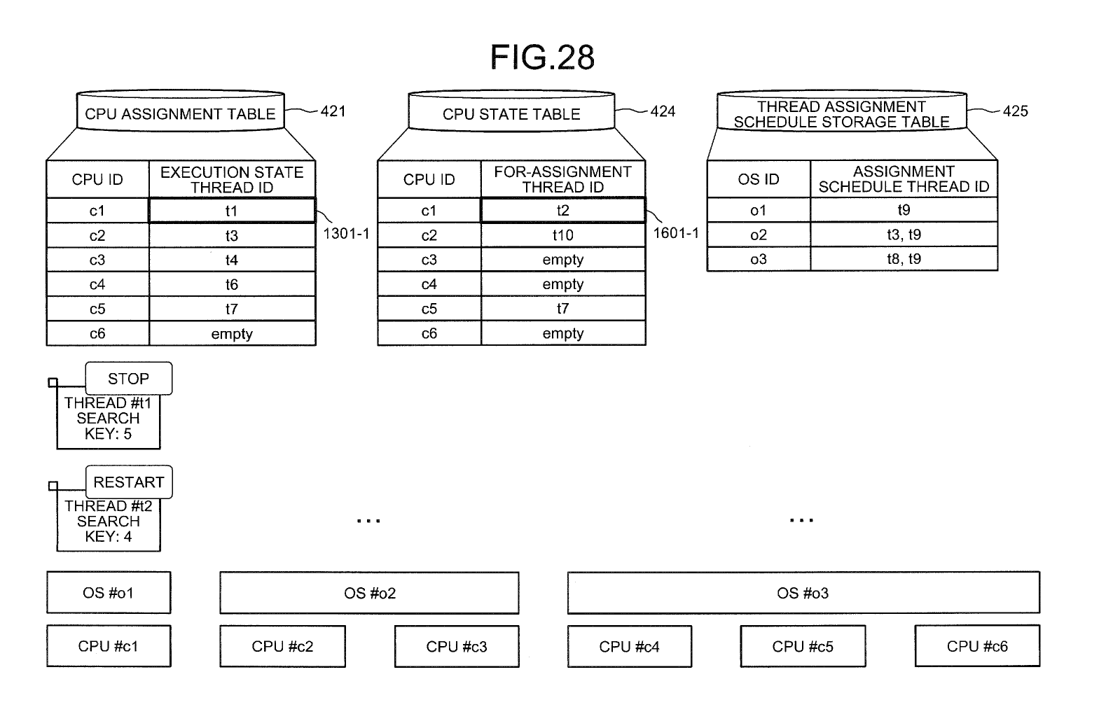

An operation of a stopping and restarting process of the unified scheduling will be described with reference to FIGS. 28 to 33. The stopping and restarting process of the unified scheduling is a process of determining whether the thread in the execution state is switched for each of the records of the CPU state table 424 and the thread assignment schedule storage table 425. If it is determined that the thread is to be switched in the stopping and restarting process of the unified scheduling, the thread currently in the execution state is stopped and another thread that is a candidate for assignment is caused to restart.

FIG. 28 is an explanatory diagram of a first stage of the stopping and restarting process of the unified scheduling. The state of the multi-processor system 100 depicted in FIG. 28 is the state after the search process is completed in FIG. 27. For the CPU #c1, the identification information of the thread is stored in the thread ID field of the record 1601-1 of the CPU state table 424 and therefore, the CPU #c1 refers to the record 1301-1 of the CPU assignment table 421, causes the thread #t1 to stop, and causes the thread #t2 that is stored in the thread ID field of the record 1601-1 of the CPU state table 424 to restart.

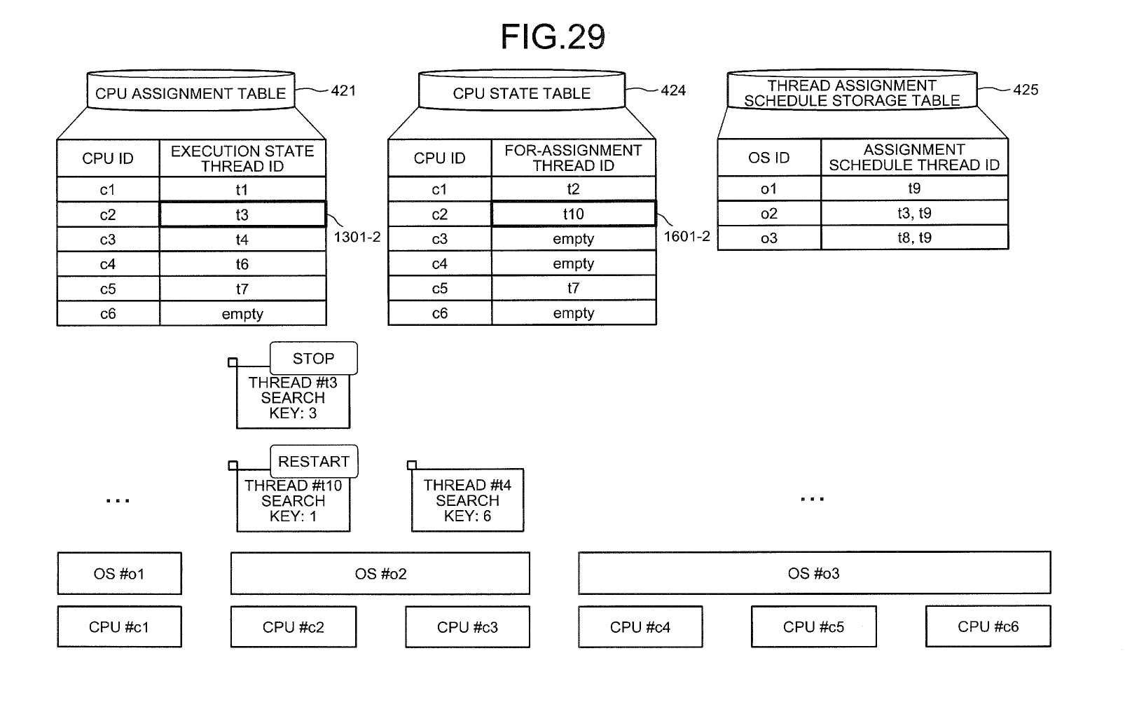

FIG. 29 is an explanatory diagram of a second stage of the stopping and restarting process of the unified scheduling. The state of the multi-processor system 100 depicted in FIG. 29 is the state after the thread #t2 is caused to restart in FIG. 28. For the CPU #c2, the identification information of the thread is stored in the thread ID field of the record 1601-2 of the CPU state table 424 and therefore, the CPU #c1 refers to the record 1301-2 of the CPU assignment table 421 and causes the thread #t3 to stop. The multi-processor system 100 causes the thread #t10 that is stored in the thread ID field of the record 1601-2 of the CPU state table 424 to restart.

After causing the thread #t10 to restart, the CPU #c1 does not especially execute any process for the CPU #c3 because no identification information of any thread is stored in the thread ID field of the record 1601-3 of the CPU state table 424. Similarly, for the records 1601-4 and 1601-6, no identification information of any thread is stored and therefore, the CPU #c1 does not especially execute any process for the CPUs #c4 and #c6. The thread stored in the record 1601-5 and the thread stored in the record 1301-5 are both the thread #t7 and therefore, the CPU #c1 again does not especially execute any process for the CPU #c5.

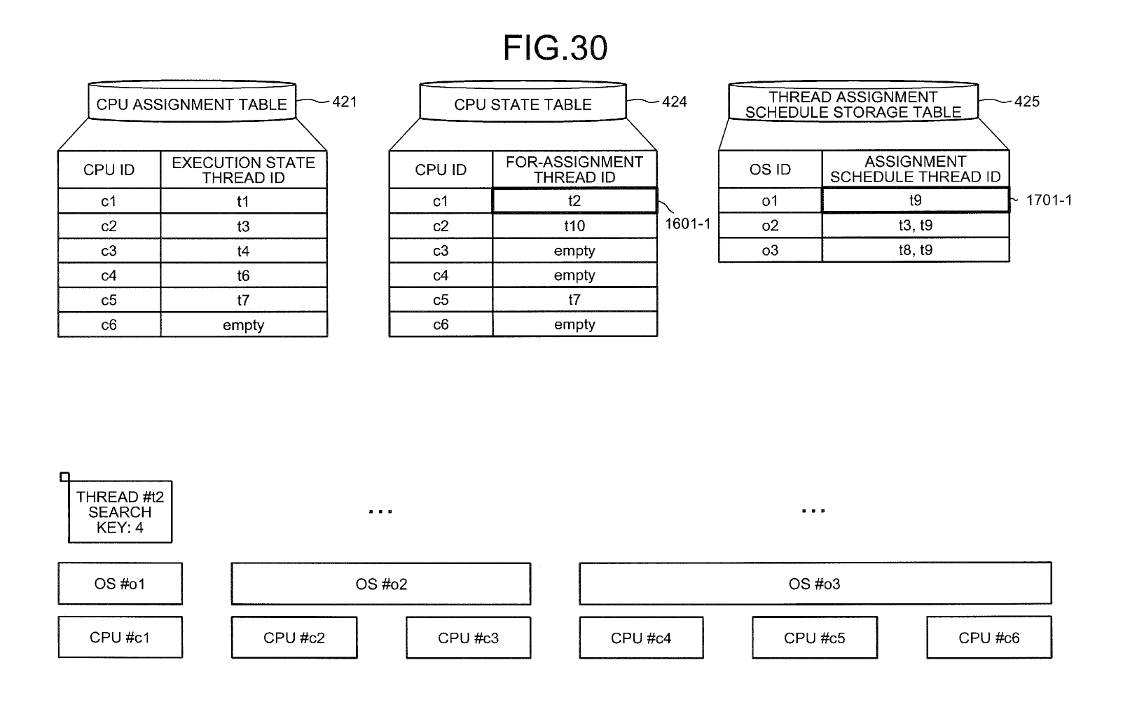

FIG. 30 is an explanatory diagram of a third stage of the stopping and restarting process of the unified scheduling. The state of the multi-processor system 100 depicted in FIG. 30 is the state after a check is executed on the records 1601-1 to 1601-6 of the CPU state table 424.

For the OS #o1, “t9” is stored, as the identification information of the thread, in the thread ID field of the record 1701-1 of the thread assignment schedule storage table 425. However, “t2” is already stored in the record 1601-1 of the CPU state table 424 and therefore, the CPU #c1 does not especially execute any process.

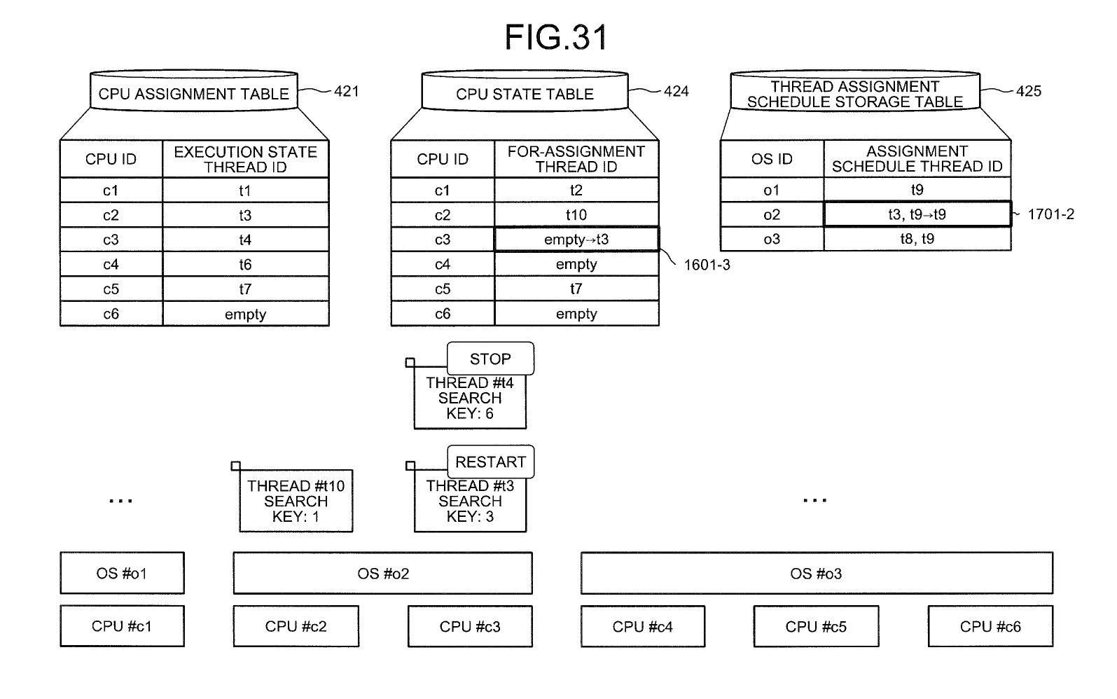

FIG. 31 is an explanatory diagram of a fourth stage of the stopping and restarting process of the unified scheduling. The state of the multi-processor system 100 depicted in FIG. 31 is the state after the check is executed on the record 1701-1 of the thread assignment schedule storage table 425.

For the OS #o2, “t3 and t9” is stored, as the identification information of the threads, in the thread ID field of the record 1701-2 of the thread assignment schedule storage table 425, and no identification information of any thread is stored in the thread ID field of the record 1601-3. Therefore, the CPU #c1 changes the thread ID field of the record 1601-3 from “empty” to “t3” and also changes the thread ID field of the record 1701-2 from “t3 and t9” to “t9”.

The CPU #c1 causes the thread #t4 to stop and causes the thread #t3 that is set in the thread ID field of the record 1601-3 to restart.

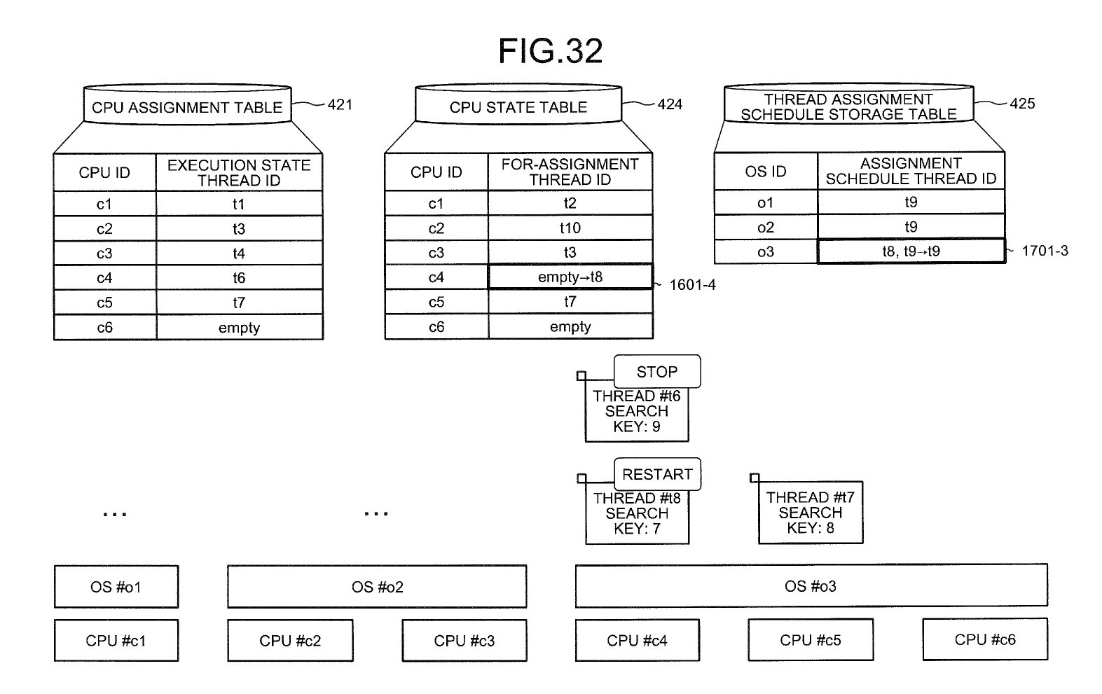

FIG. 32 is an explanatory diagram of a fifth stage of the stopping and restarting process of the unified scheduling. The state of the multi-processor system 100 depicted in FIG. 32 is the state after the check is executed on the record 1701-2 of the thread assignment schedule storage table 425.

For the OS #o3, “t8 and t9” is stored, as the identification information of the threads, in the thread ID field of the record 1701-3 of the thread assignment schedule storage table 425, and no identification information of any thread is stored in the thread ID field of the record 1601-4. Therefore, the CPU #c1 changes the thread ID field of the record 1601-4 from “empty” to “t8” and also changes the thread ID field of the record 1701-3 from “t8 and t9” to “t9”.

The CPU #c1 causes the thread #t6 to stop and causes the thread #t8 that is set in the thread ID field of the record 1601-4 to restart.

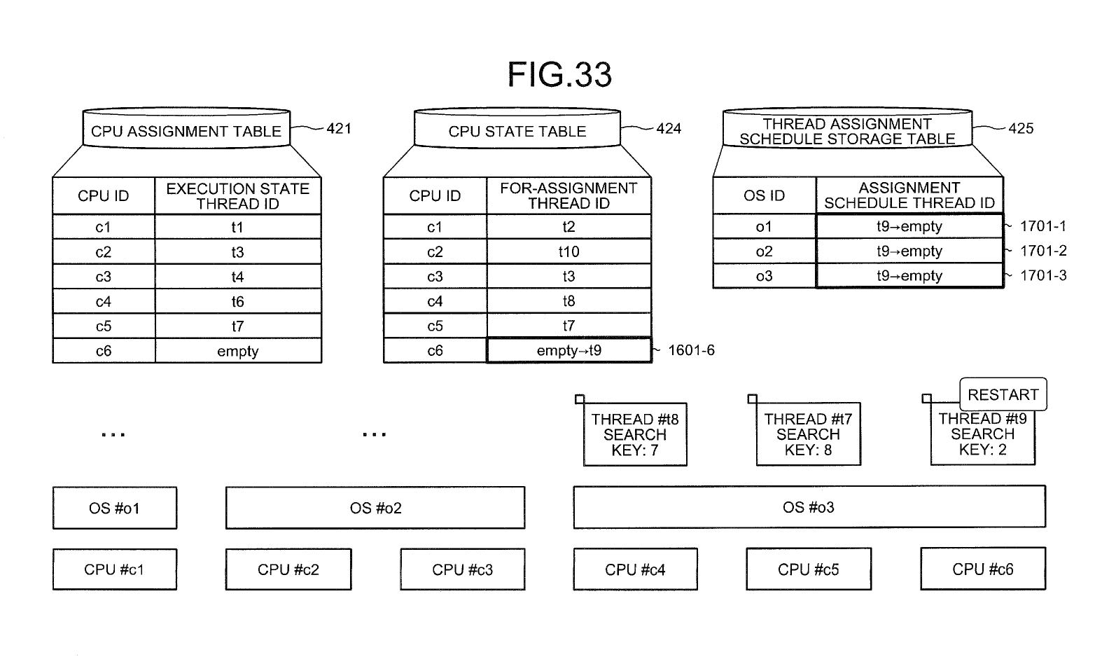

FIG. 33 is an explanatory diagram of a sixth stage of the stopping and restarting process of the unified scheduling. The state of the multi-processor system 100 depicted in FIG. 33 is the state after the check is executed on the record 1701-3 of the thread assignment schedule storage table 425.

For the OS #o3, “t9” is stored, as the identification information of the thread, in the thread ID field of the record 1701-3 of the thread assignment schedule storage table 425, and no identification information of any thread is stored in the thread ID field of the record 1601-6. Therefore, the CPU #c1 changes the thread ID field of the record 1601-6 from “empty” to “t9” and also changes the thread ID fields of the records 1701-1 to 1701-3 each from “t9” to “empty”.

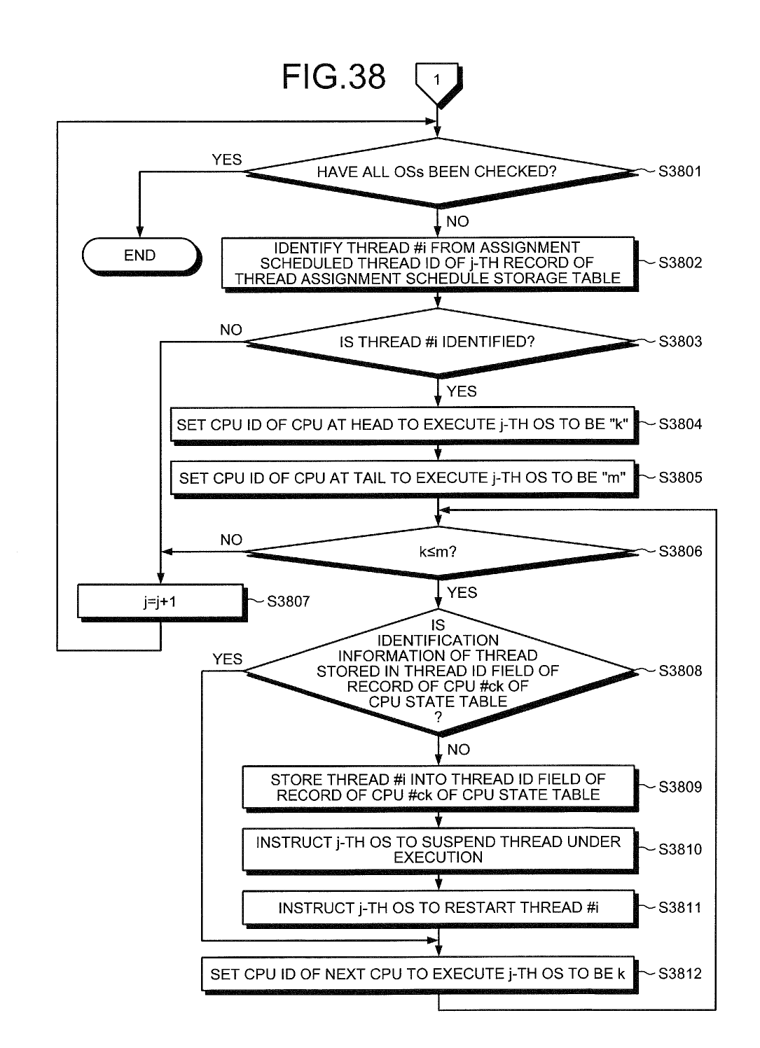

The result of the unified scheduling is as follows. The threads executed by the CPUs #c1 to #c4 respectively are changed from: #t1 to #t2; #t3 to #t10; #t4 to #t3; and #t6 to #t8. The threads executed by the CPUs #c5 and #c6 are continuously #t7 and #t9. A process of unified scheduling will be described with reference to FIG. 38. The process of unified scheduling may be executed by any one of the CPUs #c1 to #c6. For simplification of description, in the embodiment, description will be made taking an example of a case where the CPU #c1 executes the process of unified scheduling.

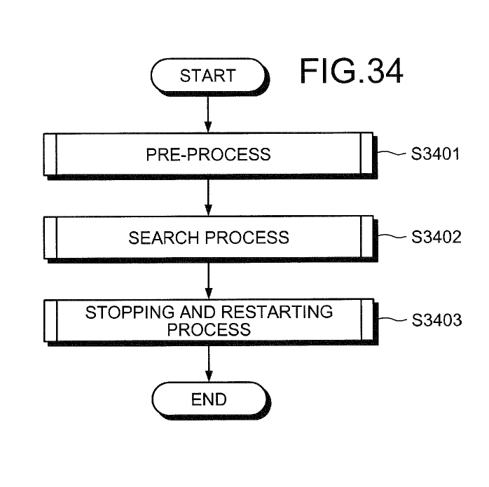

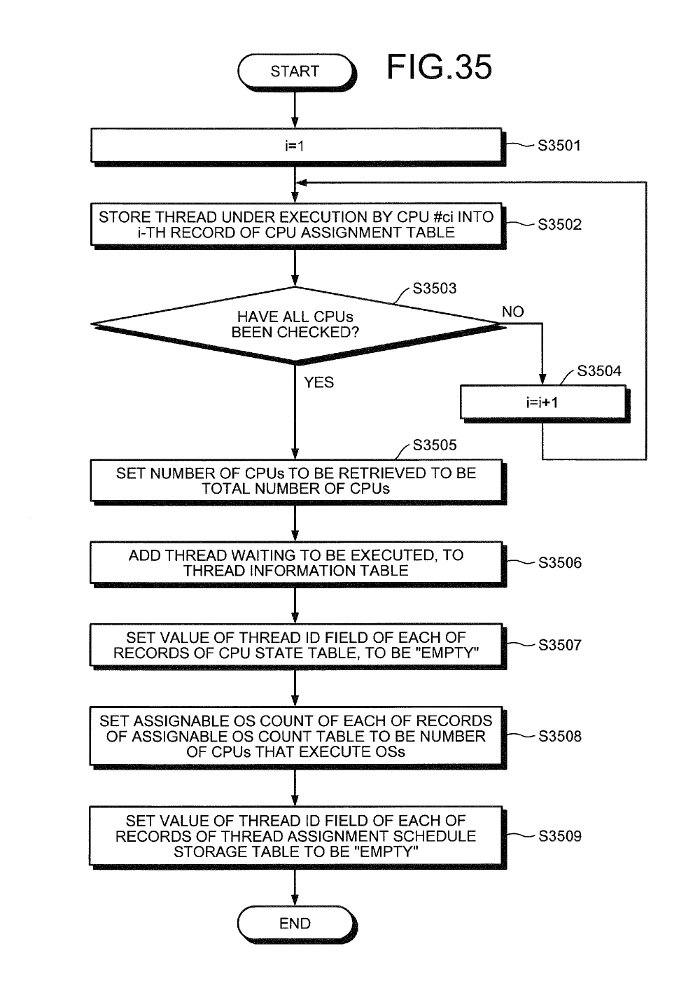

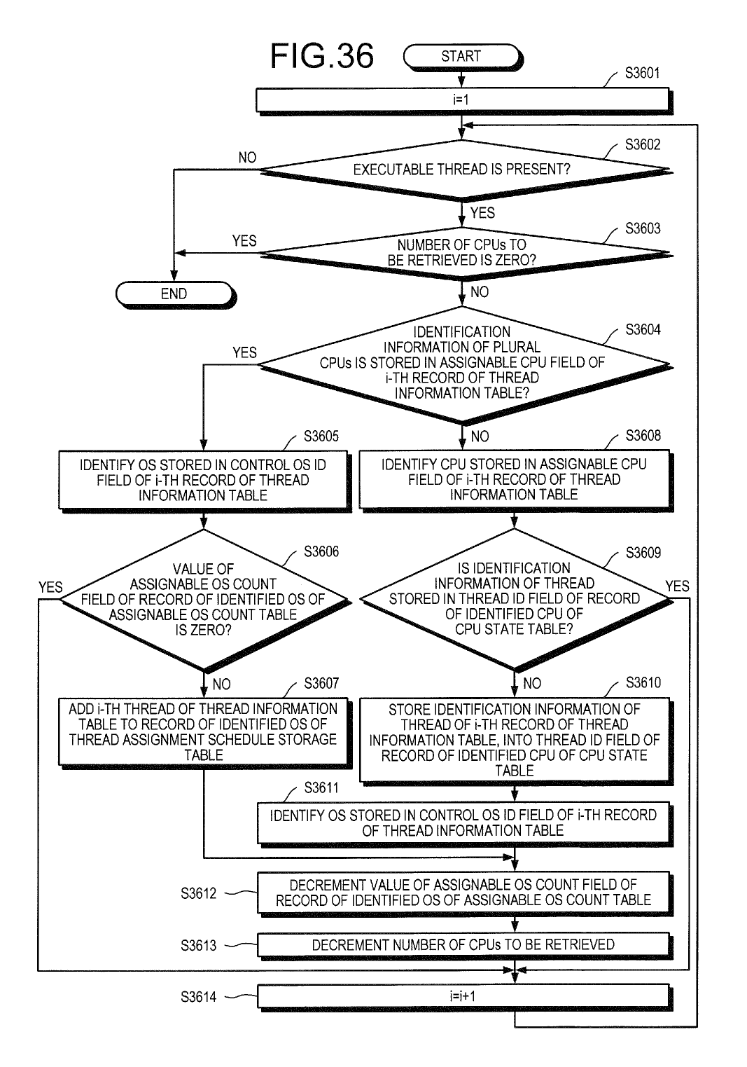

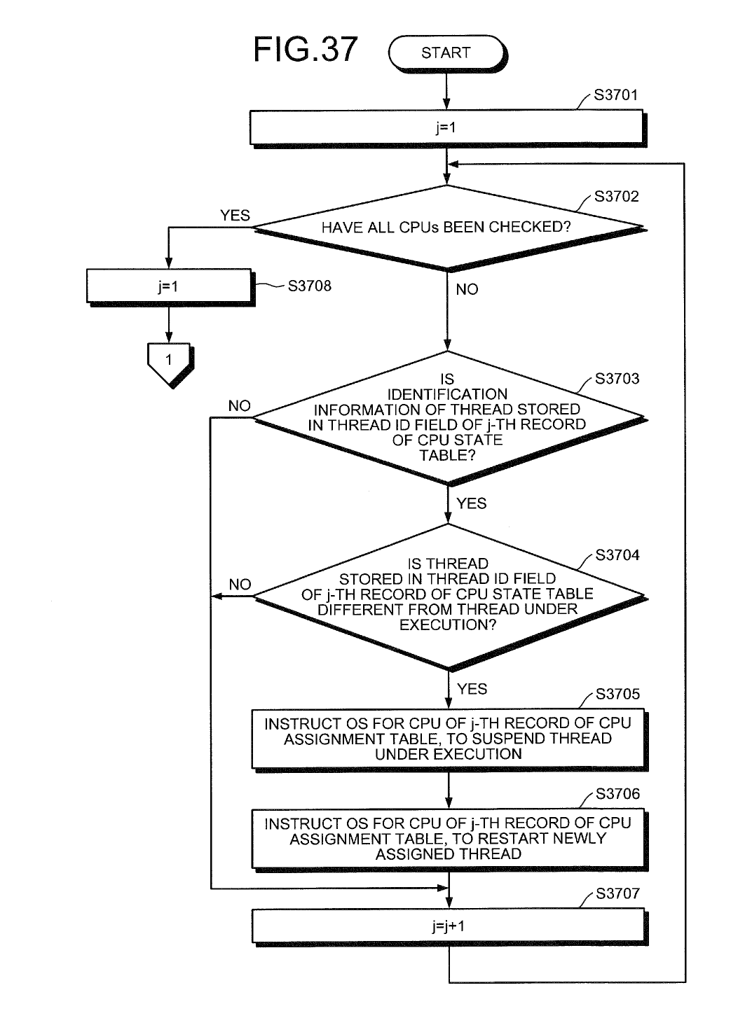

FIG. 34 is a flowchart of an example of a procedure for the process of unified scheduling. The process of unified scheduling is a process of switching the threads for the whole multi-processor system 100. The CPU #c1 executes a pre-process (step S3401). The details of the pre-process will be described later with reference to FIG. 35. The CPU #c1 executes the search process (step S3402). The details of the search process will be described later with reference to FIG. 36. The CPU #c1 executes the stopping and restarting process (step S3403). The details of the stopping and restarting process will be described later with reference to FIGS. 37 and 38. After the execution of the process at step S3403 comes to an end, the CPU #c1 causes the process of unified scheduling to come to an end. The execution of the process of unified scheduling enables the multi-processor system 100 to switch the threads for the entire multi-processor system 100.

FIG. 35 is a flowchart of an example of a procedure for a pre-process of the unified scheduling. As a pre-process of the unified scheduling, the CPU #c1 sets a variable “i” to be “one” (step S3501), stores the thread under execution by the CPU #ci into the i-th record of the CPU assignment table 421 (step S3502), and determines whether all the CPUs have been checked (step S3503). If the CPU #c1 determines that not all the CPUs have been checked (step S3503: NO), the CPU #c1 increments the variable i (step S3504). After the execution of the operation at step S3504 comes to an end, the CPU #c1 advances to the operation at step S3502.

If the CPU #c1 determines that all the CPUs have been checked (step S3503: YES), the CPU #c1 sets the number of CPUs to be retrieved to be the total number of the CPUs (step S3505), adds the thread waiting to be executed, to the thread information table 422 (step S3506), and sets the value of the thread ID field of each of the records of the CPU state table 424, to be “empty” (step S3507). The CPU #c1 sets the assignable OS number of each of the records of the assignable OS count table 423 to be the number of CPUs that execute the OSs (step S3508) and also sets the value of the thread ID field of each of the records of the thread assignment schedule storage table 425 to be “empty” (step S3509). After the execution of the operation at step S3509 comes to an end, the CPU #c1 causes the pre-process of the unified scheduling to come to an end. The execution of the pre-process of the unified scheduling enables the multi-processor system 100 to prepare for the search process of the unified scheduling.

FIG. 36 is a flowchart of an example of a procedure for the search process of the unified scheduling. The search process of the unified scheduling is a process of searching for and retrieving for each CPU, a thread that is a candidate to be assigned to the CPU.

The CPU #c1 sets the variable i to be one (step S3601) and determines whether an executable thread is present (step S3602). If the CPU #c1 determines that an executable thread is present (step S3602: YES), the CPU #c1 determines whether the number of CPUs to be retrieved is zero (step S3603). If the CPU #c1 determines that no executable thread is present (step S3602: NO) or if the CPU #c1 determines that the number of CPUs to be retrieved is zero (step S3603: YES), the CPU #c1 causes the search process of the unified scheduling to come to an end.

If the CPU #c1 determines that the number of CPUs to be retrieved is not zero (step S3603: NO), the CPU #c1 determines whether identification information of plural CPUs is stored in the assignable CPU field of the i-th record of the thread information table 422 (step S3604). If the CPU #c1 determines that the identification information of plural CPUs is stored (step S3604: YES), the CPU #c1 identifies the OS stored in the control OS ID field of the i-th record of the thread information table 422 (step S3605).

The operation at step S3605 is described for simplification of description and therefore, may be omitted from the actual processing content. If the operation at step S3605 is not executed, the CPU #c1 can acquire the identified OS described later, by referring the control OS ID field of the i-th record of the thread information table 422, at each session.

The CPU #c1 determines whether the value of the assignable OS number field of the record of the identified OS of the assignable OS count table 423 is zero (step S3606). If the CPU #c1 determines that the value of the assignable OS number field is not zero (step S3606: NO), the CPU #c1 adds the i-th thread of the thread information table 422 to the record of the identified OS of the thread assignment schedule storage table 425 (step S3607).

If the CPU #c1 determines that the identification information of one CPU is stored (step S3604: NO), the CPU #c1 identifies the CPU stored in the assignable CPU field of the i-th record of the thread information table 422 (step S3608) and determines whether the identification information of a thread is stored in the thread ID field of the record of the identified CPU of the CPU state table 424 (step S3609). If the CPU #c1 determines that no identification information is stored in the thread ID field (step S3609: NO), the CPU #c1 stores the identification information of the thread of the i-th record of the thread information table 422, into the thread ID field of the record of the identified CPU of the CPU state table 424 (step S3610) and identifies the OS stored in the control OS ID field of the i-th record of the thread information table 422 (step S3611).

After the execution of the operation at step S3607 or S3611 comes to an end, the CPU #c1 decrements the value of the assignable OS number field of the record of the identified OS of the assignable OS count table 423 (step S3612) and decrements the number of CPUs to be retrieved (step S3613).

If the CPU #c1 determines that the value of the assignable OS number field is zero (step S3606: YES), if the CPU #c1 determines that the identification information of a thread is stored in the thread ID field (step S3609: YES), or after the execution of the operation at step S3613 comes to an end, the CPU #c1 increments the variable i (step S3614). After the execution of the operation at step S3614 comes to an end, the CPU #c1 advances to the operation at step S3602. The execution of the search process of the unified scheduling enables the multi-processor system 100 to execute the process of searching for and retrieving for each CPU, a thread to be a candidate for assignment to the CPU.

FIG. 37 is a flowchart (Part I) of an example of a procedure for the stopping and restarting process of the unified scheduling. The stopping and restarting process of the unified scheduling is a process of determining for each record of the CPU state table 424 and the thread assignment schedule storage table 425, whether a thread in the execution state is to be switched and, if switching is determined, further causing the thread currently in the execution state to stop and causing a thread that is a candidate for assignment to restart.

The CPU #c1 sets a variable “j” to be one (step S3701) and determines whether all the CPUs have been checked (step S3702). If the CPU #c1 determines that a CPU not yet checked is present (step S3702: NO), the CPU #c1 determines whether the identification information of a thread is stored in the thread ID field of the j-th record of the CPU state table 424 (step S3703). If the CPU #c1 determines that the identification information of a thread is stored in the thread ID field (step S3703: YES), the CPU #c1 determines whether the thread stored in the thread ID field of the j-th record of the CPU state table 424 is different from the thread under execution (step S3704).

If the CPU #c1 determines that the thread stored in the thread ID field is different from the thread under execution (step S3704: YES), the CPU #c1 instructs the OS for the CPU of the j-th record of the CPU assignment table 421, to suspend the thread under execution (step S3705) and further instructs the OS for the CPU of the j-th record of the CPU assignment table 421, to restart the newly assigned thread (step S3706). The OS control app 101 executed by the CPU #c1 invokes the API to suspend the threads of the OSs #o1 to #o3 as a specific method of instructing the suspension. Similarly, the OS control app 101 invokes the API to restart.

If the CPU #c1 determines that no identification information of a thread is stored in the thread ID field (step S3703: NO), if the CPU #c1 determines that the thread stored in the thread ID field matches the thread under execution (step S3704: NO), or after the execution of the operation at step S3706 comes to an end, the CPU #c1 increments the variable j (step S3707). After the execution of the operation at step S3707 comes to an end, the CPU #c1 advances to the operation at step S3702. If the CPU #c1 determines that all the CPUs have been checked (step S3702: YES), the CPU #c1 sets the variable j to be one (step S3708). After the execution of the operation at step S3708 comes to an end, the CPU #c1 advances to the operation at step S3801 depicted in FIG. 38.

FIG. 38 is a flowchart (Part II) of the example of the procedure for the stopping and restarting process of the unified scheduling. The CPU #c1 determines whether all the OSs have been checked (step S3801). If the CPU #c1 determines that all the OSs have been checked (step S3801: YES), the CPU #c1 causes the stopping and restarting process of the unified scheduling to come to an end.

If the CPU #c1 determines that an OS not yet checked is present (step S3801: NO), the CPU #c1 identifies the thread #i from the assignment scheduled thread ID of the j-th record of the thread assignment schedule storage table 425 (step S3802) and determines whether the thread #i can be identified (step S3803). If the CPU #c1 determines that the thread can be identified (step S3803: YES), the CPU #c1 sets the CPU ID of the CPU at the head to execute the j-th OS to be “k” (step S3804) and sets the CPU ID of the CPU at the tail to execute the j-th OS to be “m” (step S3805). The CPU #c1 determines if k is less than or equal to m (step S3806). If the CPU #c1 determines that the thread cannot be identified (step S3803: NO) or if the CPU #c1 determines that k is greater than m (step S3806: NO), the CPU #c1 increments the variable j (step S3807). After the execution of the operation at step S3807 comes to an end, the CPU #c1 advances to the operation at step S3801.

If the CPU #c1 determines that k is less than or equal to m (step S3806: YES), the CPU #c1 determines whether the identification information of a thread is stored in the thread ID field of the record of the CPU #ck of the CPU state table 424 (step S3808). If the CPU #c1 determines that no identification information of a thread is stored in the thread ID field (step S3808: NO), the CPU #c1 stores the thread #i into the thread ID field of the record of the CPU #ck of the CPU state table 424 (step S3809), and instructs the j-th OS to suspend the thread under execution (step S3810) and further instructs the j-th OS to restart the thread #i (step S3811).

If the CPU #c1 determines that the identification information of a thread is stored in the thread ID field (step S3808: YES) or after the execution of the operation at step S3811, the CPU #c1 sets the CPU ID of the next CPU to execute the j-th OS to be k (step S3812). After the execution of the operation at step S3812 comes to an end, the CPU #c1 advances the operation at step S3806. The execution of the stopping and restarting process of the unified scheduling enables the multi-processor system 100 to cause the thread to stop and restart based on the result of the search.

As described, according to the multi-processor system 100, if the synchronization process for which an execution request is issued is not a synchronization process for threads executed by OSs that are different from one another, the synchronization process is executed using each storage area that is specific to the CPU executing the OS. Thereby, the multi-processor system 100 does not have to use the global memory #gm, which is a storage area shared among the plural CPUs, and consequently, the processing performance of the multi-processor system 100 is improved. When the processing result of the synchronization process is written into the global memory #gm, access of the global memory #gm takes a long time and the processing performance of the multi-processor system 100 drops.

According to the multi-processor system 100, if the synchronization process for which the execution request is issued is a synchronization process for threads executed by the OSs that are different from one another, the synchronization process is executed using each storage area specific to the CPU executing the OS. Thereby, the multi-processor system 100 can execute the synchronization process by operation according to the specifications of the multi-processor system 100.

According to the multi-processor system 100, when a thread is executed that issues the execution request for the synchronization process, information that is used to identify the synchronization process for the threads executed by the OSs that are different from one another may be updated. Thereby, the multi-processor system 100 can improve processing performance because the frequency of using the global memory #gm is reduced when the number of the synchronization processes are executed as the synchronization processes between threads executed by OSs that are different from one another is reduced.

According to the multi-processor system 100, whether the synchronization process is a synchronization process for threads executed by OSs that are different from one another may be determined based on the operation mode of the multi-processor system 100. A change in the operation mode causes the processing content of the executed thread to change and therefore, a thread may be present that does not issue an execution request for a synchronization process. Therefore, whether the synchronization process is a synchronization process for threads executed by OSs that are different from one another is determined for each of the operation modes and thereby, the processing performance of the multi-processor system 100 is likely to be improved.

According to the multi-processor system 100, when an OS is detected that has finished executing all the threads assigned thereto, among the threads waiting to be executed, one thread is selected from among threads executable by the detected OS, and the selected thread may be executed by the detected OS. Thereby, one CPU executes only one thread and is not obstructed by any other process, thereby facilitating satisfaction of real time restrictions prescribing the execution of a predetermined process by a thread within a predetermined time period.

It is assumed that the multi-processor system 100 detects an OS that has finished executing all the threads assigned thereto. In this case, according to the multi-processor system 100, among the threads waiting to be executed, one thread may be selected from among the threads executable by the CPU executing the detected OS, and the selected thread may be executed by the detected OS. Thereby, one CPU executes only one thread and is not obstructed by any other process, thereby facilitating satisfaction of real time restrictions prescribing the execution of a predetermined process by a thread within a predetermined time period. Preferential execution of a thread that is executable only by a specific CPU enables the thread whose condition for execution is strict can be executed earlier.

One of the reasons why the threads executable by the CPUs and threads not executable by the CPUs are present though the same OSs are used, is the presence or the absence of some of the instruction sets. For example, when one of two CPUs retains an instruction set such as single instruction multiple data (SIMD), a thread using an SIMD instruction is executable by the one CPU and a thread using no SIMD instruction and an ordinary instruction for CPUs is executable by both of the CPUs.

In the multi-processor system 100 according to the embodiment, one of the plural OSs is the real time OS and this OS is applicable to any apparatus when the apparatus acts as a heterogeneous processor. For example, the multi-processor system 100 is applicable to a copy machine, a facsimile machine, a set-top box, a video recorder, and a mobile telephone.

The execution control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to an aspect of the present embodiments, improved processing performance of a multi-processor system is facilitated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An execution control method executed by a first processor of a multi-processor system controlled by a plurality of operating systems (OSs), the execution control method comprising:
determining by referring to first information that is stored in a storage unit and identifies a synchronization process for threads executed by OSs that are different from one another and among the OSs, whether a synchronization process for which an execution request is issued by a thread that is executed by a first OS that is among the OSs and controls the first processor, is the synchronization process for threads executed by OSs that are different from one another; and
causing the first OS to execute the synchronization process for which the execution request is issued, using a storage area accessible by the first OS and specific to the first processor, upon determining that the synchronization process is not the synchronization process for threads executed by OSs that are different from one another and among the OSs.

2. The execution control method according to claim 1, further comprising
executing the synchronization process for which the execution request is issued, using a storage area accessible by the OSs, upon determining that the synchronization process for which the execution request is issued by the thread executed by the first OS is the synchronization process for threads executed by OSs that are different from one another.

3. The execution control method according to claim 1, further comprising:
correlating, when any one OS among the OSs executes a thread that issues an execution request for a synchronization process, the thread that issued the execution request for the synchronization process and the OS that executes the thread; and
executing a process of updating the first information based on a result obtained at the correlating, wherein
the determining includes determining by referring to the updated first information, whether the synchronization process for which the execution request is issued is the synchronization process for threads executed by OSs that are different from one another.

4. The execution control method according to claim 1, wherein
the storage unit stores the first information for each operation mode of the multi-processor system, and
the determining includes determining by referring to the first information and based on the operation mode of the multi-processor system, whether the synchronization process for which the execution request is issued is the synchronization process for threads executed by OSs that are different from one another.

5. The execution control method according to claim 1, further comprising:
selecting from among threads waiting to be executed in the multi-processor system and when an OS that has finished executing all threads assigned thereto is detected among the OSs, one thread executable by the detected OS; and
causing the detected OS to execute the selected thread.

6. The execution control method according to claim 1, further comprising:
selecting from among threads waiting to be executed in the multi-processor system and when an OS that has finished executing all threads assigned thereto is detected among the OSs, one thread executable by a processor that executes the detected OS; and
causing the detected OS to execute the selected thread.

7. A multi-processor system that is controlled by a plurality of operating systems (OSs), the multi-processor system comprising:
a first processor; and
a storage unit that stores first information that identifies a synchronization process for threads executed by OSs that are different from one another and among the OSs, wherein
the first processor is configured to:
determine by referring to the first information, whether a synchronization process for which an execution request is issued by a thread executed by a first OS that is among the OSs and controls the first processor, is the synchronization process for threads executed by OSs that are different from one another; and
cause the first OS to execute the synchronization process for which the execution request is issued, using a storage area accessible by the first OS and specific to the first processor, upon determining that the synchronization process is not the synchronization process for threads executed by OSs that are different from one another.
